(19) United States
(12) Patent Application Publication
(10) Pub. No.: US 2023/0289564 A1
(43) Pub. Date: Sep. 14, 2023

(54) NEURAL NETWORK-BASED COMMUNICATION METHOD AND DEVICE

(71) Applicant: LG ELECTRONICS INC., Seoul (KR)

(72) Inventors: Bonghoe KIM, Seoul (KR); Jongwoong SHIN, Seoul (KR); Byounghoon KIM, Seoul (KR)

(73) Assignee: LG ELECTRONICS INC., Seoul (KR)

(21) Appl. No.: 18/014,703

(22) PCT Filed: Jul. 6, 2020
(86) PCT No.: PCT/KR2020/008772

§ 371 Date: Jan. 5, 2023

(51) Int. Cl. G06N 3/0455; H04W 72/231

(52) U.S. Cl. CPC G06N 3/0455; H04W 72/231

(57) ABSTRACT

According to the present specification, it is possible to design a transmitter and a receiver configured in a neural network through end-to-end optimization. In addition, it is possible to design a neural network encoder capable of improving the distance characteristic of a codeword. Furthermore, proposed is a method for signaling information about neural network parameters of a neural network encoder and a neural network decoder.

### BACKGROUND OF THE DISCLOSURE

### Field of the Disclosure

This disclosure relates to wireless communication.

### Related Art

6G systems are aimed to (i) very high data rates per device, (ii) very large numbers of connected devices, (iii) global connectivity, (iv) very low latency, (v) lower energy consumption of battery-free IoT devices, (vi) ultra-reliable connectivity, and (vii) connected intelligence with machine learning capabilities. The vision of 6G systems can be four aspects: intelligent connectivity, deep connectivity, holographic connectivity and ubiquitous connectivity.

Recently, attempts have been made to integrate AI with wireless communication systems, this has been focused on the field of application layer, network layer, and in particular, wireless resource management and allocation using deep learning. However, such research is gradually developing into a MAC layer and a physical layer, and in particular, attempts are being made to combine deep learning with wireless transmission in the physical layer. For fundamental signal processing and communication mechanisms, AI-based physical layer transmission means applying signal processing and communication mechanisms based on AI drivers rather than traditional communication frameworks. For example, deep learning-based channel coding and decoding, deep learning-based signal estimation and detection, deep learning-based MIMO mechanism, AI-based resource scheduling and allocation.

Various attempts have been made to apply neural networks to communication systems. Among them, attempts to apply to the physical layer are mainly considering optimizing a specific function of a receiver. For example, performance can be improved by configuring a channel decoder as a neural network. Alternatively, performance can be improved by implementing a MIMO detector as a neural network in a MIMO system having a plurality of transmit/receive antennas.

Another approach is to construct both a transmitter and a receiver as a neural network and perform optimization from an end-to-end perspective to improve performance, which is called an autoencoder.

### SUMMARY OF THE DISCLOSURE

In this specification, an encoder and decoder structure and training method of a neural network-based autoencoder are proposed.

Transmitters and receivers composed of neural networks can be designed through end-to-end optimization. In addition, complexity can be improved by designing a neural network encoder to improve the distance characteristics of codewords. In addition, system performance can be optimized by signaling information on neural network parameters of a neural network encoder and a neural network decoder.

Effects that can be obtained through specific examples of the present specification are not limited to the effects listed above. For example, various technical effects that a person having ordinary skill in the related art can understand or derive from this specification may exist. Accordingly, the specific effects of the present specification are not limited to those explicitly described herein, and may include various effects that can be understood or derived from the technical characteristics of the present specification.

### BRIEF DESCRIPTION OF THE DRAWINGS

FIG. 1 shows a wireless communication system to which the present disclosure can be applied.

FIG. 2 is a diagram showing a wireless protocol architecture for a user plane.

FIG. 3 is a diagram showing a wireless protocol architecture for a control plane.

FIG. 4 shows another example of a wireless communication system to which the technical features of the present disclosure can be applied.

FIG. 5 illustrates a functional division between an NG-RAN and a 5GC.

FIG. 6 illustrates an example of a frame structure that may be applied in NR.

FIG. 7 illustrates a slot structure.

FIG. 8 illustrates CORESET.

FIG. 9 is a diagram illustrating a difference between a related art control region and the CORESET in NR.

FIG. 10 illustrates an example of a frame structure for new radio access technology.

FIG. 11 illustrates a structure of a self-contained slot.

FIG. 12 is an abstract schematic diagram of a hybrid beamforming structure in terms of a TXRU and a physical antenna.

FIG. 13 shows a synchronization signal and a PBCH (SS/PBCH) block.

FIG. 14 is for explaining a method for a UE to obtain timing information.

FIG. 15 shows an example of a process of acquiring system information of a UE.

FIG. 16 is for explaining a random access procedure.

FIG. 17 is a diagram for describing a power ramping counter.

FIG. 18 is for explaining the concept of the threshold value of the SS block for the RACH resource relationship.

FIG. 19 is a flowchart illustrating an example of performing an idle mode DRX operation.

FIG. 20 illustrates a DRX cycle.

FIG. 21 shows an example of a communication structure that can be provided in a 6G system.

FIG. 22 shows an example of a perceptron structure.

FIG. 23 shows an example of a multi-perceptron structure.

FIG. 24 shows an example of a deep neural network.

FIG. 25 shows an example of a convolutional neural network.

FIG. 26 shows an example of a filter operation in a convolutional neural network.

FIG. 27 shows an example of a neural network structure in which a recurrent loop exists.

FIG. 28 illustrates an example of an operating structure of a recurrent neural network.

FIG. 29 shows an example of a neural network model.

FIG. 30 shows an example of an activated node in a neural network.

FIG. 31 shows an example of gradient calculation using the chain rule.

FIG. 32 shows an example of the basic structure of an RNN.

FIG. 33 shows an example of an autoencoder.

FIG. 34 shows an example of an encoder structure and a decoder structure of a turbo autoencoder.

FIG. 35 shows an example in which f_{i,θ} is implemented as a 2-layer CNN in a neural network encoder.

FIG. 36 illustrates an embodiment of g_{0i,j} of a neural network decoder composed of a 5-layer CNN.

FIG. 37 schematically illustrates the structure of an input end of an embodiment of a neural network encoder for improving distance characteristics.

FIG. 38 schematically illustrates the structure of a neural network encoder in which an interleaver is inserted to improve distance characteristics.

FIG. 39 shows the structure of one embodiment of a neural network encoder with an additional interleaver.

FIG. 40 illustrates an embodiment of a neural network encoder structure in which an accumulator is inserted into an input end.

FIG. 41 illustrates an embodiment of a neural network encoder structure concatenated with a recursive systematic convolutional code (RSC code).

FIG. 42 shows an embodiment of a neural network decoder structure for a neural network encoder structure connected with an RSC code.

FIG. 43 illustrates an embodiment of a systematic neural network encoder architecture.

FIG. 44 shows an example of a neural network training method.

FIG. 45 is a flowchart of another example of a method for training a neural network.

FIG. 46 illustrates a communication system 1 applied to the present specification.

FIG. 47 illustrates a wireless device applicable to the present disclosure.

FIG. 48 illustrates a signal processing circuit for a transmission signal.

FIG. 49 shows another example of a wireless device applied to the present disclosure.

FIG. 50 illustrates a portable device applied to the present disclosure.

FIG. 51 illustrates a vehicle or an autonomous driving vehicle applied to the present disclosure.

FIG. 52 illustrates a vehicle applied to the present disclosure.

FIG. 53 illustrates an XR device applied to the present disclosure.

FIG. 54 illustrates a robot applied to the present disclosure.

FIG. 55 illustrates an AI device applied to the present disclosure.

### DESCRIPTION OF EXEMPLARY EMBODIMENTS

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (PDCCH)”, it may mean that “PDCCH” is proposed as an example of the “control information”. In other words, the “control information” of the present specification is not limited to “PDCCH”, and “PDCCH” may be proposed as an example of the “control information”. In addition, when indicated as “control information (i.e., PDCCH)”, it may also mean that “PDCCH” is proposed as an example of the “control information”.

The following technology may be used in various wireless communication systems such as code division multiple access (CDMA), frequency division multiple access (FDMA), time division multiple access (TDMA), OFDMA (orthogonal frequency division multiple access), SC-FDMA (single carrier frequency division multiple access), and the like. CDMA may be implemented with a radio technology such as universal terrestrial radio access (UTRA) or CDMA2000. TDMA may be implemented with a radio technology such as global system for mobile communications (GSM)/general packet radio service (GPRS)/enhanced data rates for GSM evolution (EDGE). OFDMA may be implemented with a wireless technology such as institute of electrical and electronics engineers (IEEE) 802.11 (Wi-Fi), IEEE 802.16 (WiMAX), IEEE 802-20, evolved UTRA (E-UTRA), and the like. IEEE 802.16m is an evolution of IEEE 802.16e, and provides backward compatibility with a system based on IEEE 802.16e. UTRA is part of the universal mobile telecommunications system (UMTS). 3rd generation partnership project (3GPP) long term evolution (LTE) is a part of evolved UMTS (E-UMTS) that uses evolved-UMTS terrestrial radio access (E-UTRA), adopting OFDMA in downlink and adopting SC-FDMA in uplink. LTE-A (advanced) is an evolution of 3GPP LTE.

5G NR, a successor to LTE-A, is a new clean-slate mobile communication system with characteristics such as high performance, low latency, and high availability. 5G NR can utilize all available spectrum resources, including low-frequency bands below 1 GHz, medium-frequency bands between 1 GHz and 10 GHz, and high-frequency (millimeter wave) bands above 24 GHz.

For clarity of description, LTE-A or 5G NR is mainly described, but the technical spirit of the present disclosure is not limited thereto.

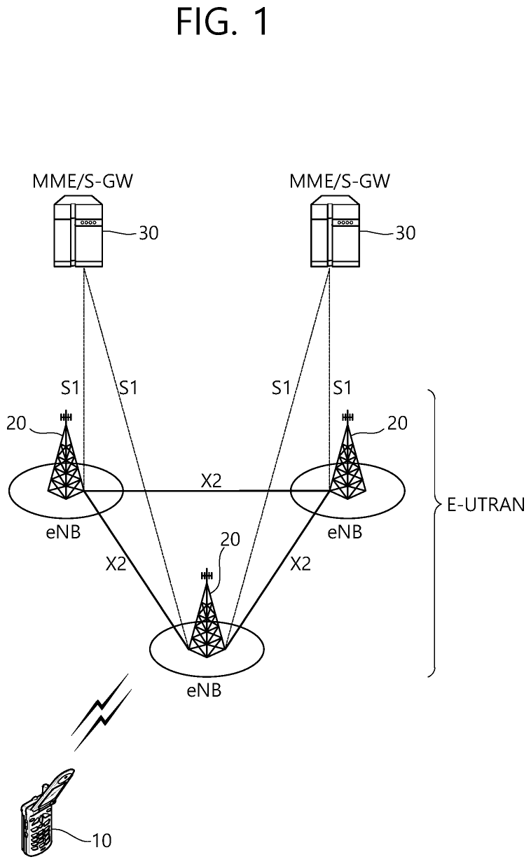

FIG. 1 shows a wireless communication system to which the present disclosure may be applied. The wireless communication system may be referred to as an Evolved-UMTS Terrestrial Radio Access Network (E-UTRAN) or a Long Term Evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNB), a base transceiver system (BTS), an access point, etc.

The BSs 20 are interconnected by means of an X2 interface. The BSs 20 are also connected by means of an S1 interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

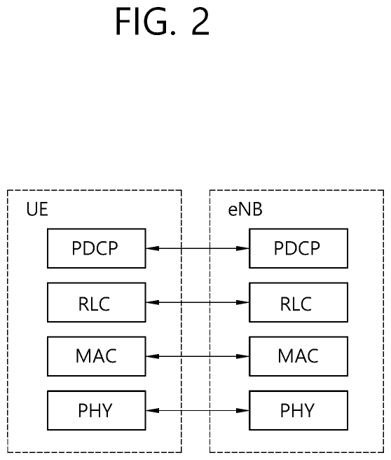

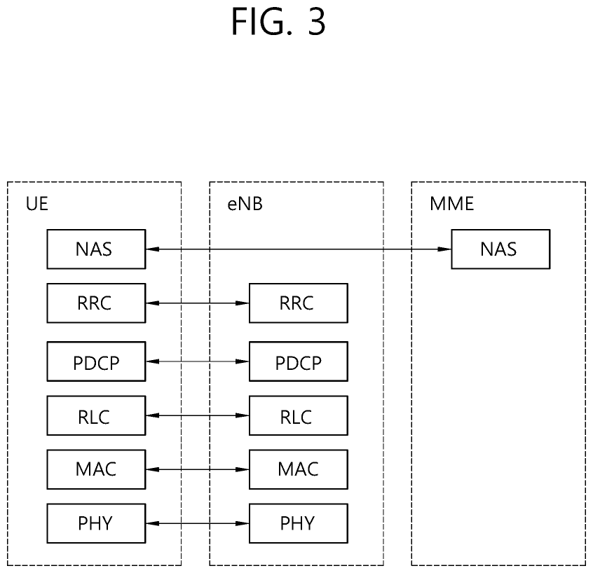

FIG. 2 is a diagram showing a wireless protocol architecture for a user plane. FIG. 3 is a diagram showing a wireless protocol architecture for a control plane. The user plane is a protocol stack for user data transmission. The control plane is a protocol stack for control signal transmission.

Referring to FIGS. 2 and 3, a PHY layer provides an upper layer(=higher layer) with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Data is moved between different PHY layers, that is, the PHY layers of a transmitter and a receiver, through a physical channel. The physical channel may be modulated according to an Orthogonal Frequency Division Multiplexing (OFDM) scheme, and use the time and frequency as radio resources.

The functions of the MAC layer include mapping between a logical channel and a transport channel and multiplexing and demultiplexing to a transport block that is provided through a physical channel on the transport channel of a MAC Service Data Unit (SDU) that belongs to a logical channel. The MAC layer provides service to a Radio Link Control (RLC) layer through the logical channel.

The functions of the RLC layer include the concatenation, segmentation, and reassembly of an RLC SDU. In order to guarantee various types of Quality of Service (QoS) required by a Radio Bearer (RB), the RLC layer provides three types of operation mode: Transparent Mode (TM), Unacknowledged Mode (UM), and Acknowledged Mode (AM). AM RLC provides error correction through an Automatic Repeat Request (ARQ).

The RRC layer is defined only on the control plane. The RRC layer is related to the configuration, reconfiguration, and release of radio bearers, and is responsible for control of logical channels, transport channels, and PHY channels. An RB means a logical route that is provided by the first layer (PHY layer) and the second layers (MAC layer, the RLC layer, and the PDCP layer) in order to transfer data between UE and a network.

The function of a Packet Data Convergence Protocol (PDCP) layer on the user plane includes the transfer of user data and header compression and ciphering. The function of the PDCP layer on the user plane further includes the transfer and encryption/integrity protection of control plane data.

What an RB is configured means a process of defining the characteristics of a wireless protocol layer and channels in order to provide specific service and configuring each detailed parameter and operating method. An RB can be divided into two types of a Signaling RB (SRB) and a Data RB (DRB). The SRB is used as a passage through which an RRC message is transmitted on the control plane, and the DRB is used as a passage through which user data is transmitted on the user plane.

If RRC connection is established between the RRC layer of UE and the RRC layer of an E-UTRAN, the UE is in the RRC connected state. If not, the UE is in the RRC idle state.

A downlink transport channel through which data is transmitted from a network to UE includes a broadcast channel (BCH) through which system information is transmitted and a downlink shared channel (SCH) through which user traffic or control messages are transmitted. Traffic or a control message for downlink multicast or broadcast service may be transmitted through the downlink SCH, or may be transmitted through an additional downlink multicast channel (MCH). Meanwhile, an uplink transport channel through which data is transmitted from UE to a network includes a random access channel (RACH) through which an initial control message is transmitted and an uplink shared channel (SCH) through which user traffic or control messages are transmitted.

Logical channels that are placed over the transport channel and that are mapped to the transport channel include a broadcast control channel (BCCH), a paging control channel (PCCH), a common control channel (CCCH), a multicast control channel (MCCH), and a multicast traffic channel (MTCH).

The physical channel includes several OFDM symbols in the time domain and several subcarriers in the frequency domain. One subframe includes a plurality of OFDM symbols in the time domain. An RB is a resources allocation unit, and includes a plurality of OFDM symbols and a plurality of subcarriers. Furthermore, each subframe may use specific subcarriers of specific OFDM symbols (e.g., the first OFDM symbol) of the corresponding subframe for a physical downlink control channel (PDCCH), that is, an L1/L2 control channel. A Transmission Time Interval (TTI) is a unit time of transmission, and may be, for example, a subframe or a slot.

Hereinafter, a new radio access technology (new RAT, NR) will be described.

As more and more communication devices require more communication capacity, there is a need for improved mobile broadband communication over existing radio access technology. Also, massive machine type communications (MTC), which provides various services by connecting many devices and objects, is one of the major issues to be considered in the next generation communication. In addition, communication system design considering reliability/latency sensitive service/UE is being discussed. The introduction of next generation radio access technology considering enhanced mobile broadband communication (eMBB), massive MTC (mMTC), ultrareliable and low latency communication (URLLC) is discussed. This new technology may be called new radio access technology (new RAT or NR) in the present disclosure for convenience.

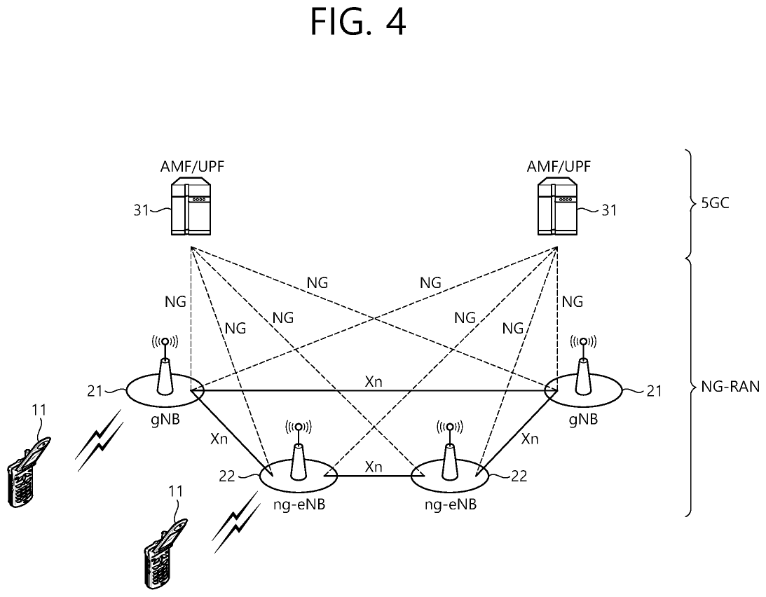

FIG. 4 illustrates another example of a wireless communication system to which technical features of the present disclosure are applicable.

Specifically, FIG. 4 shows system architecture based on a 5G new radio access technology (NR) system. Entities used in the 5G NR system (hereinafter, simply referred to as “NW”) may absorb some or all functions of the entities (e.g., the eNB, the MME, and the S-GW) introduced in FIG. 1. The entities used in the NR system may be identified by terms with “NG” to be distinguished from LTE entities.

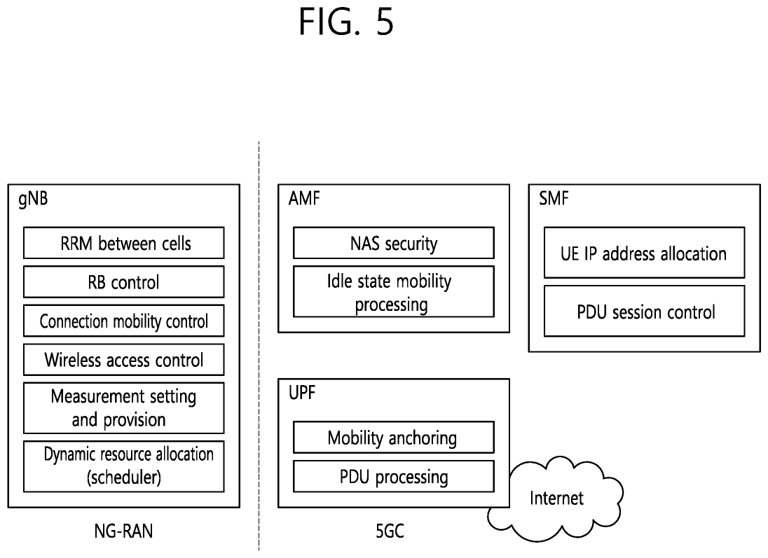

Referring to FIG. 4, the wireless communication system includes at least one UE 11, a next-generation RAN (NG-RAN), and a 5G core network (5GC). The NG-RAN includes at least one NG-RAN node. The NG-RAN node is an entity corresponding to the BS 20 illustrated in FIG. 5. The NG-RAN node includes at least one gNB 21 and/or at least one ng-eNB 22. The gNB 21 provides an end point of NR control-plane and user-plane protocols to the UE 11. The ng-eNB 22 provides an end point of E-UTRA user-plane and control-plane protocols to the UE 11.

The 5GC includes an access and mobility management function (AMF), a user plane function (UPF), and a session management function (SMF). The AMF hosts functions of NAS security and idle-state mobility processing. The AMF is an entity that includes the functions of a conventional MME. The UPF hosts functions of mobility anchoring function and protocol data unit (PDU) processing. The UPF is an entity that includes the functions of a conventional S-GW. The SMF hosts functions of UE IP address allocation and PDU session control.

The gNB and the ng-eNB are connected to each other via an Xn interface. The gNB and the ng-eNB are also connected to the 5GC through an NG interface. Specifically, the gNB and the ng-eNB are connected to the AMF through an NG-C interface, and to the UPF through an NG-U interface.

FIG. 5 illustrates a functional division between an NG-RAN and a 5GC.

Referring to FIG. 5, the gNB may provide functions such as an inter-cell radio resource management (Inter Cell RRM), radio bearer management (RB control), connection mobility control, radio admission control, measurement configuration & provision, dynamic resource allocation, and the like. The AMF may provide functions such as NAS security, idle state mobility handling, and so on. The UPF may provide functions such as mobility anchoring, PDU processing, and the like. The SMF may provide functions such as UE IP address assignment, PDU session control, and so on.

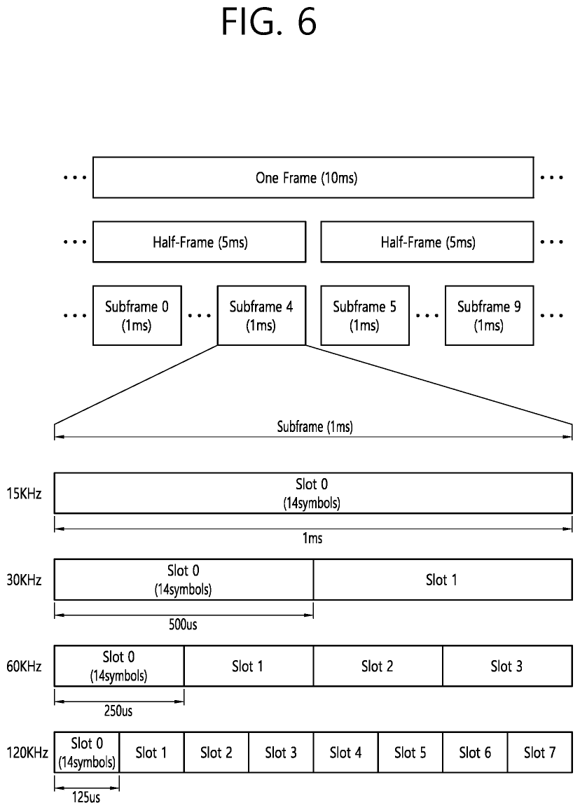

FIG. 6 illustrates an example of a frame structure that may be applied in NR.

Referring to FIG. 6, a frame may be configured in 10 milliseconds (ms), and may include 10 subframes configured in 1 ms.

In NR, uplink and downlink transmission may be composed of frames. A radio frame has a length of 10 ms and may be defined as two 5 ms half-frames (HF). The HF may be defined as five 1 ms subframes (SFs). The SF may be divided into one or more slots, and the number of slots within the SF depends on a subcarrier spacing (SCS). Each slot includes 12 or 14 OFDM(A) symbols according to a cyclic prefix (CP). In case of using a normal CP, each slot includes 14 symbols. In case of using an extended CP, each slot includes 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

One or a plurality of slots may be included in the subframe according to subcarrier spacing.

The following table 1 illustrates a subcarrier spacing configuration

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal Extended |
| 3 | 120 | Normal |
| 4 | 240 | Normal |

The following table 2 illustrates the number of slots in a frame (N^{frame,μ}ₛₗₒₜ), the number of slots in a subframe (N^{subframe,μ}ₛₗₒₜ), the number of symbols in a slot (N^{slot}_{symb}) and the like, according to subcarrier spacing configurations

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 illustrates that the number of symbols per slot, the number of slots per frame, and the number of slots per subframe vary depending on the SCS, in case of using an extended CP.

TABLE 3

| SCS (15 · 2^{μ}) | N^{slot}_{symb} | N^{frame, u}ₛₗₒₜ | N^{subframe, u}ₛₗₒₜ |
|---|---|---|---|
| 60 kHZ (μ = 2) | 12 | 40 | 4 |

In an NR system, OFDM(A) numerologies (e.g., SCS, CP length, and so on) may be differently configured between a plurality of cells integrated to one UE. Accordingly, an (absolute time) duration of a time resource (e.g., SF, slot or TTI) (for convenience, collectively referred to as a time unit (TU)) configured of the same number of symbols may be differently configured between the integrated cells.

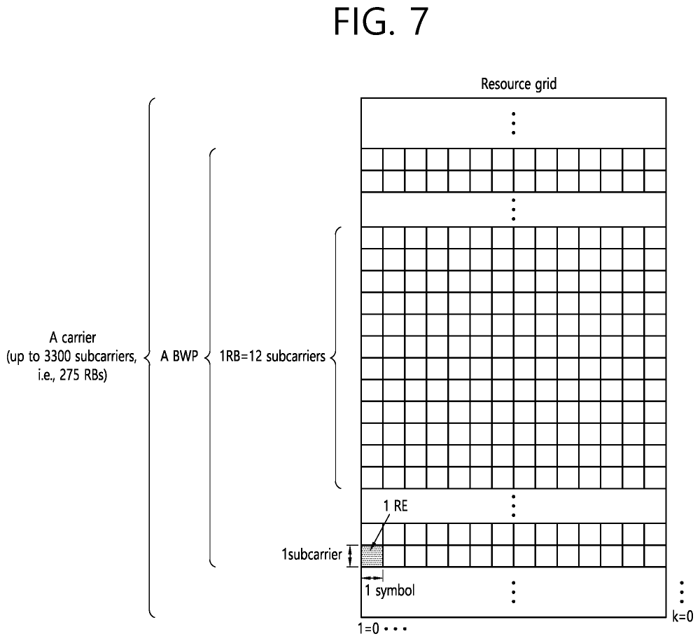

FIG. 7 illustrates a slot structure.

Referring to FIG. 7, a slot may include a plurality of symbols in a time domain. For example, in case of a normal CP, one slot may include 14 symbols. However, in case of an extended CP, one slot may include 12 symbols. Or, in case of a normal CP, one slot may include 7 symbols. However, in case of an extended CP, one slot may include 6 symbols.

A carrier may include a plurality of subcarriers in a frequency domain. A resource block (RB) may be defined as a plurality of consecutive subcarriers (e.g., 12 subcarriers) in the frequency domain. A bandwidth part (BWP) may be defined as a plurality of consecutive (physical) resource blocks ((P)RBs) in the frequency domain, and the BWP may correspond to one numerology (e.g., SCS, CP length, and so on). The carrier may include up to N (e.g., 5) BWPs. Data communication may be performed via an activated BWP. In a resource grid, each element may be referred to as a resource element (RE), and one complex symbol may be mapped thereto.

A physical downlink control channel (PDCCH) may include one or more control channel elements (CCEs) as illustrated in the following table 4.

TABLE 4

| Aggregation level | Number of CCEs |
|---|---|
| 1 | 1 |
| 2 | 2 |
| 4 | 4 |
| 8 | 8 |
| 16 | 16 |

That is, the PDCCH may be transmitted through a resource including 1, 2, 4, 8, or 16 CCEs. Here, the CCE includes six resource element groups (REGs), and one REG includes one resource block in a frequency domain and one orthogonal frequency division multiplexing (OFDM) symbol in a time domain.

Meanwhile, a new unit called a control resource set (CORESET) may be introduced in the NR. The UE may receive a PDCCH in the CORESET.

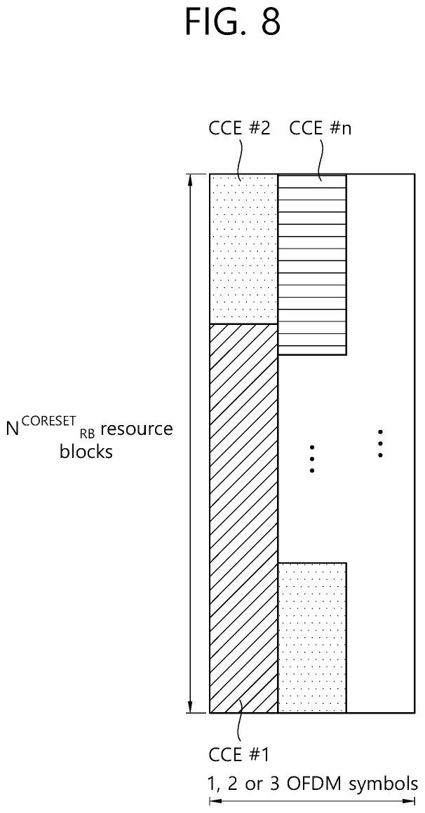

FIG. 8 illustrates CORESET.

Referring to FIG. 8, the CORESET includes N^{CORESET}_{RB} number of resource blocks in the frequency domain, and N^{CORESET}_{symb} ∈{1, 2, 3} number of symbols in the time domain. N^{CORESET}_{RB} and N^{CORESET}_{symb} may be provided by a base station via higher layer signaling. As illustrated in FIG. 8, a plurality of CCEs (or REGs) may be included in the CORESET.

The UE may attempt to detect a PDCCH in units of 1, 2, 4, 8, or 16 CCEs in the CORESET. One or a plurality of CCEs in which PDCCH detection may be attempted may be referred to as PDCCH candidates.

A plurality of CORESETs may be configured for the UE.

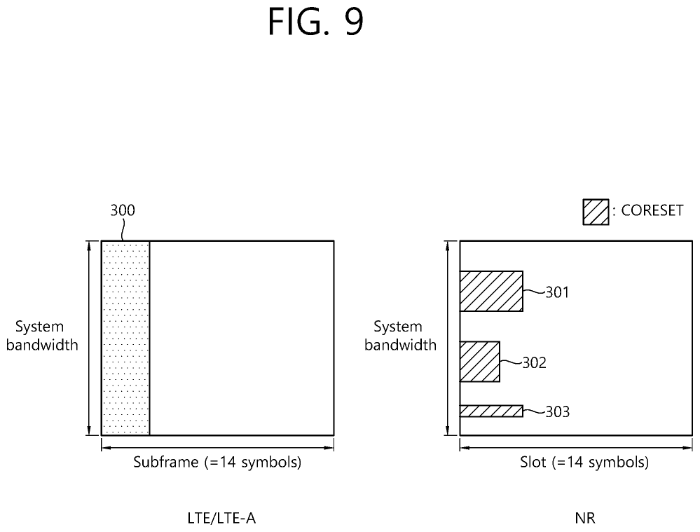

FIG. 9 is a diagram illustrating a difference between a related art control region and the CORESET in NR.

Referring to FIG. 9, a control region 300 in the related art wireless communication system (e.g., LTE/LTE-A) is configured over the entire system band used by a base station (BS). All the UEs, excluding some (e.g., eMTC/NB-IoT UE) supporting only a narrow band, shall be able to receive wireless signals of the entire system band of the BS in order to properly receive/decode control information transmitted by the BS.

On the other hand, in NR, CORESET described above was introduced. CORESETs 301, 302, and 303 are radio resources for control information to be received by the UE and may use only a portion, rather than the entirety of the system bandwidth. The BS may allocate the CORESET to each UE and may transmit control information through the allocated CORESET. For example, in FIG. 9, a first CORESET 301 may be allocated to UE 1, a second CORESET 302 may be allocated to UE 2, and a third CORESET 303 may be allocated to UE 3. In the NR, the UE may receive control information from the BS, without necessarily receiving the entire system band.

The CORESET may include a UE-specific CORESET for transmitting UE-specific control information and a common CORESET for transmitting control information common to all UEs.

Meanwhile, NR may require high reliability according to applications. In such a situation, a target block error rate (BLER) for downlink control information (DCI) transmitted through a downlink control channel (e.g., physical downlink control channel (PDCCH)) may remarkably decrease compared to those of conventional technologies. As an example of a method for satisfying requirement that requires high reliability, content included in DCI can be reduced and/or the amount of resources used for DCI transmission can be increased. Here, resources can include at least one of resources in the time domain, resources in the frequency domain, resources in the code domain and resources in the spatial domain.

Meanwhile, in NR, the following technologies/features can be applied.

<Self-Contained Subframe Structure>

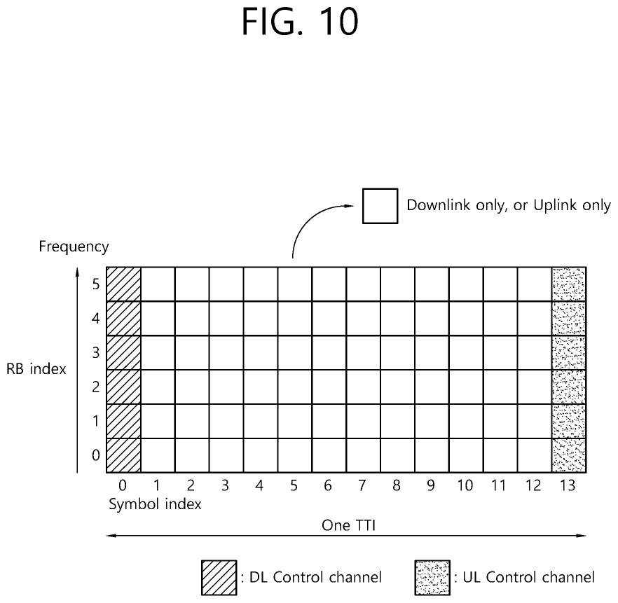

FIG. 10 illustrates an example of a frame structure for new radio access technology.

In NR, a structure in which a control channel and a data channel are time-division-multiplexed within one TTI, as shown in FIG. 10, can be considered as a frame structure in order to minimize latency.

In FIG. 10, a shaded region represents a downlink control region and a black region represents an uplink control region. The remaining region may be used for downlink (DL) data transmission or uplink (UL) data transmission. This structure is characterized in that DL transmission and UL transmission are sequentially performed within one subframe and thus DL data can be transmitted and UL ACK/NACK can be received within the subframe. Consequently, a time required from occurrence of a data transmission error to data retransmission is reduced, thereby minimizing latency in final data transmission.

In this data and control TDMed subframe structure, a time gap for a base station and a UE to switch from a transmission mode to a reception mode or from the reception mode to the transmission mode may be required. To this end, some OFDM symbols at a time when DL switches to UL may be set to a guard period (GP) in the self-contained subframe structure.

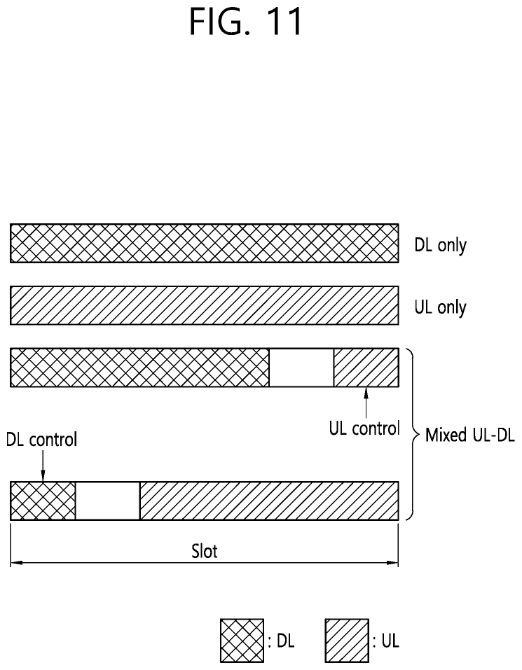

FIG. 11 illustrates a structure of a self-contained slot.

Referring to FIG. 11, one slot may have a self-contained structure in which all of a DL control channel, DL or UL data, and a UL control channel may be included. For example, first N symbols (hereinafter, DL control region) in the slot may be used to transmit a DL control channel, and last M symbols (hereinafter, UL control region) in the slot may be used to transmit a UL control channel. N and M are integers greater than or equal to 0. A resource region (hereinafter, a data region) which exists between the DL control region and the UL control region may be used for DL data transmission or UL data transmission. For example, the following configuration may be considered. Respective durations are listed in a temporal order.
1. DL only configuration
2. UL only configuration
3. Mixed UL-DL configuration
   DL region+Guard period (GP)+UL control region
   DL control region+GP+UL region

Here, the DL region may be (i) DL data region, (ii) DL control region+DL data region. The UL region may be (i) UL data region, (ii) UL data region+UL control region

A PDCCH may be transmitted in the DL control region, and a physical downlink shared channel (PDSCH) may be transmitted in the DL data region. A physical uplink control channel (PUCCH) may be transmitted in the UL control region, and a physical uplink shared channel (PUSCH) may be transmitted in the UL data region. Downlink control information (DCI), for example, DL data scheduling information, UL data scheduling information, and the like, may be transmitted on the PDCCH. Uplink control information (UCI), for example, ACK/NACK information about DL data, channel state information (CSI), and a scheduling request (SR), may be transmitted on the PUCCH. A GP provides a time gap in a process in which a BS and a UE switch from a TX mode to an RX mode or a process in which the BS and the UE switch from the RX mode to the TX mode. Some symbols at the time of switching from DL to UL within a subframe may be configured as the GP.

<Analog Beamforming #1>

Wavelengths are shortened in millimeter wave (mmW) and thus a large number of antenna elements can be installed in the same area. That is, the wavelength is 1 cm at 30 GHz and thus a total of 100 antenna elements can be installed in the form of a 2-dimensional array at an interval of 0.5 lambda (wavelength) in a panel of 5×5 cm. Accordingly, it is possible to increase a beamforming (BF) gain using a large number of antenna elements to increase coverage or improve throughput in mmW.

In this case, if a transceiver unit (TXRU) is provided to adjust transmission power and phase per antenna element, independent beamforming per frequency resource can be performed. However, installation of TXRUs for all of about 100 antenna elements decreases effectiveness in terms of cost. Accordingly, a method of mapping a large number of antenna elements to one TXRU and controlling a beam direction using an analog phase shifter is considered. Such analog beamforming can form only one beam direction in all bands and thus cannot provide frequency selective beamforming.

Hybrid beamforming (BF) having a number B of TXRUs which is smaller than Q antenna elements can be considered as an intermediate form of digital BF and analog BF. In this case, the number of directions of beams which can be simultaneously transmitted are limited to B although it depends on a method of connecting the B TXRUs and the Q antenna elements.

<Analog Beamforming #2>

When a plurality of antennas is used in NR, hybrid beamforming which is a combination of digital beamforming and analog beamforming is emerging. Here, in analog beamforming (or RF beamforming) an RF end performs precoding (or combining) and thus it is possible to achieve the performance similar to digital beamforming while reducing the number of RF chains and the number of D/A (or A/D) converters. For convenience, the hybrid beamforming structure may be represented by N TXRUs and M physical antennas. Then, the digital beamforming for the L data layers to be transmitted at the transmitting end may be represented by an N by L matrix, and the converted N digital signals are converted into analog signals via TXRUs, and analog beamforming represented by an M by N matrix is applied.

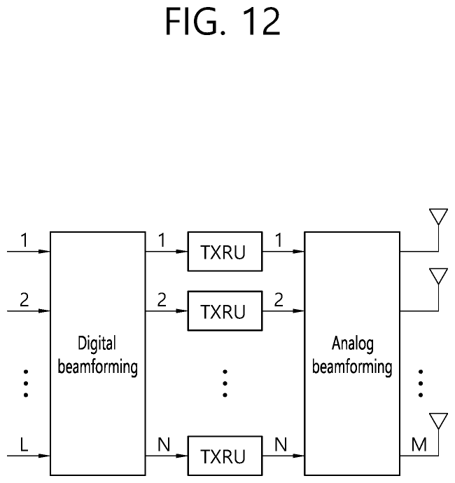

FIG. 12 is an abstract diagram of a hybrid beamforming structure from the viewpoint of the TXRU and the physical antenna.

In FIG. 12, the number of digital beams is L, and the number of analog beams is N. Furthermore, in the NR system, a direction of supporting more efficient beamforming to a UE located in a specific area is considered by designing the base station to change analog beamforming in units of symbols. Further, when defining N specific TXRUs and M RF antennas as one antenna panel in FIG. 12, in the NR system, a method of introducing a plurality of antenna panels to which hybrid beamforming independent of each other can be applied is being considered.

As described above, when the base station uses a plurality of analog beams, since analog beams advantageous for signal reception may be different for each UE, a beam sweeping operation, in which at least for a synchronization signal, system information, paging, etc., a plurality of analog beams to be applied by the base station in a specific subframe are changed for each symbol, that allows all UEs to have a reception occasion is being considered.

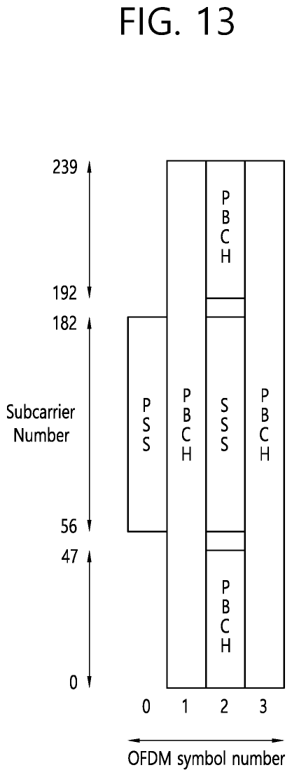

FIG. 13 shows a synchronization signal and a PBCH (SS/PBCH) block.

Referring to FIG. 13, an SS/PBCH block may include a PSS and an SSS, each of which occupies one symbol and 127 subcarriers, and a PBCH, which spans three OFDM symbols and 240 subcarriers where one symbol may include an unoccupied portion in the middle reserved for the SSS. The periodicity of the SS/PBCH block may be configured by a network, and a time position for transmitting the SS/PBCH block may be determined on the basis of subcarrier spacing.

Polar coding may be used for the PBCH. A UE may assume band-specific subcarrier spacing for the SS/PBCH block as long as a network does not configure the UE to assume different subcarrier spacings.

The PBCH symbols carry frequency-multiplexed DMRS thereof. QPSK may be used for the PBCH. 1008 unique physical-layer cell IDs may be assigned.

For a half frame with SS/PBCH blocks, first symbol indices for candidate SS/PBCH blocks are determined according to subcarrier spacing of SS/PBCH blocks, which will be described later.
Case A—Subcarrier spacing 15 kHz: The first symbols of the candidate SS/PBCH blocks have an index of {2, 8}+14*n. For carrier frequencies less than or equal to 3 GHz, n=0, 1. For carrier frequencies greater than 3 GHz and less than or equal to 6 GHz, n=0, 1, 2, 3.
Case B—Subcarrier spacing 30 kHz: The first symbols of the candidate SS/PBCH blocks have an index of {4, 8, 16, 20}+28*n. For carrier frequencies less than or equal to 3 GHz, n=0. For carrier frequencies greater than 3 GHz and less than or equal to 6 GHz, n=0, 1.
Case C—Subcarrier spacing 30 kHz: The first symbols of candidate SS/PBCH blocks have an index of {2, 8}+14*n. For carrier frequencies less than or equal to 3 GHz, n=0, 1. For carrier frequencies greater than 3 GHz and less than or equal to 6 GHz, n=0, 1, 2, 3.
Case D—Subcarrier spacing 120 kHz: The first symbols of the candidate SS/PBCH blocks have an index of {4, 8, 16, 20}+28*n. For carrier frequencies greater than 6 GHz, n=0, 1, 2, 3, 5, 6, 7, 8, 10, 11, 12, 13, 15, 16, 17, 18.
Case E—Subcarrier spacing 240 kHz: The first symbols of the candidate SS/PBCH blocks have an index of {8, 12, 16, 20, 32, 36, 40, 44}+56*n. For carrier frequencies greater than 6 GHz, n=0, 1, 2, 3, 5, 6, 7, 8.

Candidate SS/PBCH blocks in a half frame are indexed in ascending order from 0 to L−1 on the time axis. The UE shall determine 2 LSB bits for L=4 and 3 LSB bits for L>4 of the SS/PBCH block index per half frame from one-to-one mapping with the index of the DMRS sequence transmitted in the PBCH. For L=64, the UE shall determine 3 MSB bits of the SS/PBCH block index per half frame by the PBCH payload bits.

By the higher layer parameter ‘SSB-transmitted-SIB1’, the index of SS/PBCH blocks in which the UE cannot receive other signals or channels in REs overlapping with REs corresponding to SS/PBCH blocks can be set. In addition, according to the higher layer parameter ‘SSB-transmitted’, the index of SS/PBCH blocks per serving cell in which the UE cannot receive other signals or channels in REs overlapping with REs corresponding to the SS/PBCH blocks can be set. The setting by ‘SSB-transmitted’ may take precedence over the setting by ‘SSB-transmitted-SIB1’. A periodicity of a half frame for reception of SS/PBCH blocks per serving cell may be set by a higher layer parameter ‘SSB-periodicityServingCell’. If the UE does not set the periodicity of the half frame for the reception of SS/PBCH blocks, the UE shall assume the periodicity of the half frame. The UE may assume that the periodicity is the same for all SS/PBCH blocks in the serving cell.

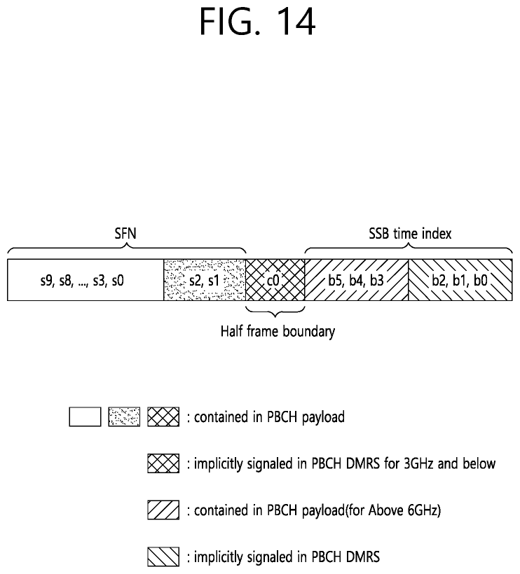

FIG. 14 is for explaining a method for a UE to obtain timing information.

First, the UE may obtain 6-bit SFN information through the MIB (Master Information Block) received in the PBCH. In addition, SFN 4 bits can be obtained in the PBCH transport block.

Second, the UE may obtain a 1-bit half frame indicator as part of the PBCH payload. In less than 3 GHz, the half frame indicator may be implicitly signaled as part of the PBCH DMRS for Lmax=4.

Finally, the UE may obtain the SS/PBCH block index by the DMRS sequence and the PBCH payload. That is, LSB 3 bits of the SS block index can be obtained by the DMRS sequence for a period of 5 ms. Also, the MSB 3 bits of the timing information are explicitly carried within the PBCH payload (for >6 GHz).

In initial cell selection, the UE may assume that a half frame with SS/PBCH blocks occurs with a periodicity of 2 frames. Upon detecting the SS/PBCH block, the UE determines that a control resource set for the Type0-PDCCH common search space exists if k_{SSB}≤23 for FR1 and k_{SSB}≤11 for FR2. The UE determines that there is no control resource set for the Type0-PDCCH common search space if k_{SSB}>23 for FR1 and k_{SSB}>11 for FR2.

For a serving cell without transmission of SS/PBCH blocks, the UE acquires time and frequency synchronization of the serving cell based on reception of the SS/PBCH blocks on the PSCell or the primary cell of the cell group for the serving cell.

Hereinafter, system information acquisition will be described.

System information (SI) is divided into a master information block (MIB) and a plurality of system information blocks (SIBs) where:
the MIB is transmitted always on a BCH according to a period of 40 ms, is repeated within 80 ms, and includes parameters necessary to obtain system information block type1 (SIB1) from a cell;
SIB1 is periodically and repeatedly transmitted on a DL-SCH. SIB1 includes information on availability and scheduling (e.g., periodicity or SI window size) of other SIBs. Further, SIB1 indicates whether the SIBs (i.e., the other SIBs) are periodically broadcast or are provided by request. When the other SIBs are provided by request, SIB1 includes information for a UE to request SI;
SIBs other than SIB1 are carried via system information (SI) messages transmitted on the DL-SCH. Each SI message is transmitted within a time-domain window (referred to as an SI window) periodically occurring;
For a PSCell and SCells, an RAN provides required SI by dedicated signaling. Nevertheless, a UE needs to acquire an MIB of the PSCell in order to obtain the SFN timing of a SCH (which may be different from an MCG). When relevant SI for a SCell is changed, the RAN releases and adds the related SCell. For the PSCell, SI can be changed only by reconfiguration with synchronization (sync).

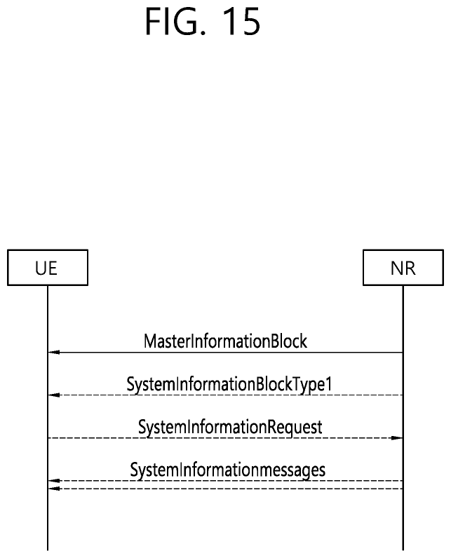

FIG. 15 shows an example of a process of acquiring system information of a UE.

According to FIG. 15, the UE may receive the MIB from the network and then receive the SIB1. Thereafter, the UE may transmit a system information request to the network, and may receive a ‘SystemInformation message’ from the network in response thereto.

The UE may apply a system information acquisition procedure for acquiring AS (access stratum) and NAS (non-access stratum) information.

UEs in RRC_IDLE and RRC_INACTIVE states shall ensure (at least) valid versions of MIB, SIB1 and SystemInformationBlockTypeX (according to the relevant RAT support for UE-controlled mobility).

The UE in RRC_CONNECTED state shall guarantee valid versions of MIB, SIB1, and SystemInformationBlockTypeX (according to mobility support for the related RAT).

The UE shall store the related SI obtained from the currently camped/serving cell. The SI version obtained and stored by the UE is valid only for a certain period of time. The UE may use this stored version of the SI after, for example, cell reselection, return from out of coverage, or system information change indication.

Hereinafter, random access will be described.

The random access procedure of the UE can be summarized as in the following table 5.

TABLE 5

| | Type of signal | Action/Acquired Information |
|---|---|---|
| Step 1 | Uplink PRACH | Initial beam acquisition |
| | preamble | Random Election of RA-Preamble ID |
| Step 2 | Random access | Timing arrangement information |
| | response | RA-preamble ID |
| | on DL-SCH | Initial uplink grant, temporary C-RNTI |
| Step 3 | Uplink | RRC connection request |
| | transmission on | UE identifier |
| | UL-SCH | |
| Step 4 | Contention resolution | C-RNTI on PDCCH for initial access |
| | of downlink | C-RNTI on PDCCH for UE in |
| | | RRC_CONNECTED state |

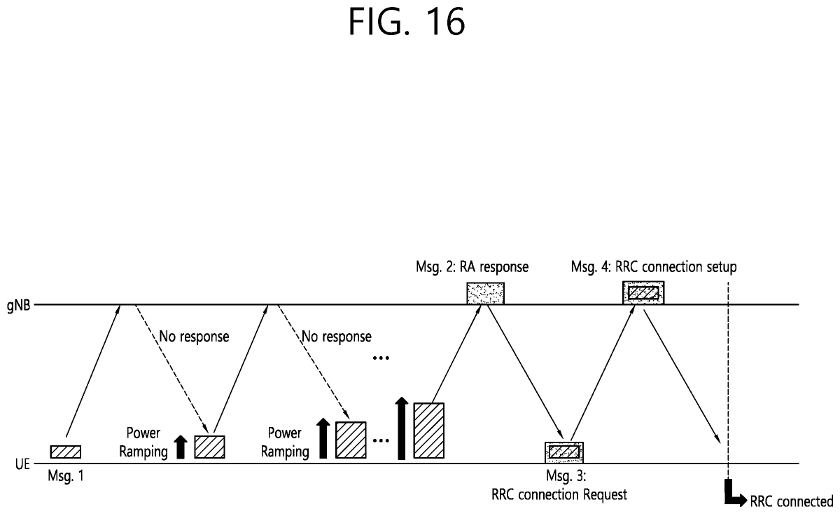

FIG. 16 is for explaining a random access procedure.

Referring to FIG. 16, first, the UE may transmit a physical random access channel (PRACH) preamble in uplink as message (Msg) 1 of the random access procedure.

Random access preamble sequences having two different lengths are supported. A long sequence of length 839 applies to subcarrier spacings of 1.25 kHz and 5 kHz, and a short sequence of length 139 applies to subcarrier spacings of 15, 30, 60, and 120 kHz. A long sequence supports an unrestricted set and a limited set of types A and B, whereas a short sequence supports only an unrestricted set.

A plurality of RACH preamble formats are defined with one or more RACH OFDM symbols, a different cyclic prefix (CP), and a guard time. The PRACH preamble configuration to be used is provided to the UE as system information.

If there is no response to Msg1, the UE may retransmit the power-rammed PRACH preamble within a prescribed number of times. The UE calculates the PRACH transmission power for retransmission of the preamble based on the most recent estimated path loss and power ramping counter. If the UE performs beam switching, the power ramping counter does not change.

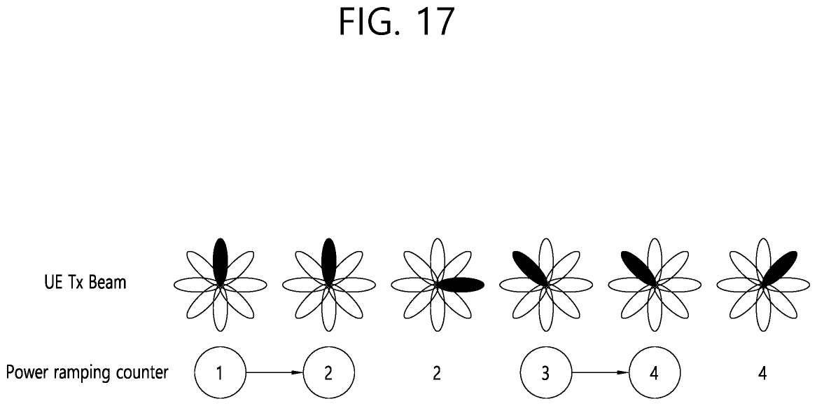

FIG. 17 is a diagram for describing a power ramping counter.

The UE may perform power ramping for retransmission of the random access preamble based on the power ramping counter. Here, as described above, the power ramping counter does not change when the UE performs beam switching during PRACH retransmission.

Referring to FIG. 17, when the UE retransmits the random access preamble for the same beam, the UE increments the power ramping counter by 1 as the power ramping counter increases from 1 to 2 and from 3 to 4. However, when the beam is changed, the power ramping counter does not change during PRACH retransmission.

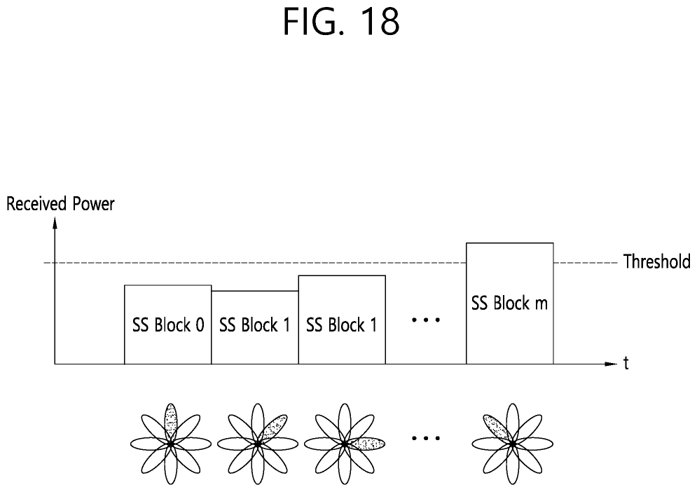

FIG. 18 is for explaining the concept of the threshold value of the SS block for the RACH resource relationship.

The system information informs the UE of the relationship between SS blocks and RACH resources. The threshold of the SS block for the RACH resource relationship is based on RSRP and network configuration. Transmission or retransmission of the RACH preamble is based on an SS block that satisfies a threshold. Accordingly, in the example of FIG. 18, since the SS block m exceeds the threshold of the received power, the RACH preamble is transmitted or retransmitted based on the SS block m.

Thereafter, when the UE receives a random access response on the DL-SCH, the DL-SCH may provide timing arrangement information, an RA-preamble ID, an initial uplink grant, and a temporary C-RNTI.

Based on the information, the UE may perform uplink transmission on the UL-SCH as Msg3 of the random access procedure. Msg3 may include the RRC connection request and UE identifier.

In response, the network may transmit Msg4, which may be treated as a contention resolution message, in downlink. By receiving this, the UE can enter the RRC connected state.

<Bandwidth Part (BWP)>

In the NR system, a maximum of 400 MHz can be supported per component carrier (CC). If a UE operating in such a wideband CC operates with RF for all CCs turn on all the time, UE battery consumption may increase. Or, considering use cases operating in one wideband CC (e.g., eMBB, URLLC, mMTC, etc.), different numerologies (e.g., subcarrier spacings (SCSs)) can be supported for different frequency bands in the CC. Or, UEs may have different capabilities for a maximum bandwidth. In consideration of this, an eNB may instruct a UE to operate only in a part of the entire bandwidth of a wideband CC, and the part of the bandwidth is defined as a bandwidth part (BWP) for convenience. A BWP can be composed of resource blocks (RBs) consecutive on the frequency axis and can correspond to one numerology (e.g., a subcarrier spacing, a cyclic prefix (CP) length, a slot/mini-slot duration, or the like).

Meanwhile, the eNB can configure a plurality of BWPs for a UE even within one CC. For example, a BWP occupying a relatively small frequency region can be set in a PDCCH monitoring slot and a PDSCH indicated by a PDCCH can be scheduled on a BWP wider than the BWP. When UEs converge on a specific BWP, some UEs may be set to other BWPs for load balancing. Otherwise, BWPs on both sides of a bandwidth other than some spectra at the center of the bandwidth may be configured in the same slot in consideration of frequency domain inter-cell interference cancellation between neighbor cells. That is, the eNB can configure at least one DL/UL BWP for a UE associated with(=related with) a wideband CC and activate at least one of DL/UL BWPs configured at a specific time (through L1 signaling or MAC CE or RRC signaling), and switching to other configured DL/UL BWPs may be indicated (through L1 signaling or MAC CE or RRC signaling) or switching to a determined DL/UL BWP may occur when a timer value expires on the basis of a timer. Here, an activated DL/UL BWP is defined as an active DL/UL BWP. However, a UE may not receive a configuration for a DL/UL BWP when the UE is in an initial access procedure or RRC connection is not set up. In such a situation, a DL/UL BWP assumed by the UE is defined as an initial active DL/UL BWP.

<DRX (Discontinuous Reception)>

Discontinuous Reception (DRX) refers to an operation mode in which a UE (User Equipment) reduces battery consumption so that the UE can discontinuously receive a downlink channel. That is, the UE configured for DRX can reduce power consumption by discontinuously receiving the DL signal.

The DRX operation is performed within a DRX cycle indicating a time interval in which On Duration is periodically repeated. The DRX cycle includes an on-duration and a sleep duration (or a DRX opportunity). The on-duration indicates a time interval during which the UE monitors the PDCCH to receive the PDCCH.

DRX may be performed in RRC (Radio Resource Control) IDLE state (or mode), RRC_INACTIVE state (or mode), or RRC_CONNECTED state (or mode). In RRC_IDLE state and RRC_INACTIVE state, DRX may be used to receive paging signal discontinuously.
RRC_IDLE state: a state in which a radio connection (RRC connection) is not established between the base station and the UE.
RRC_INACTIVE state: A wireless connection (RRC connection) is established between the base station and the UE, but the wireless connection is inactive.
RRC_CONNECTED state: a state in which a radio connection (RRC connection) is established between the base station and the UE.

DRX can be basically divided into idle mode DRX, connected DRX (C-DRX), and extended DRX.

DRX applied in the IDLE state may be named idle mode DRX, and DRX applied in the CONNECTED state may be named connected mode DRX (C-DRX).

Extended/Enhanced DRX (eDRX) is a mechanism that can extend the cycles of idle mode DRX and C-DRX, and Extended/Enhanced DRX (eDRX) can be mainly used for (massive) IoT applications. In idle mode DRX, whether to allow eDRX may be configured based on system information (e.g., SIB1). SIB1 may include an eDRX-allowed parameter. The eDRX-allowed parameter is a parameter indicating whether idle mode extended DRX is allowed.

<Idle Mode DRX>

In the idle mode, the UE may use DRX to reduce power consumption. One paging occasion (paging occasion; PO) is a subframe in which P-RNTI (Paging-Radio Network Temporary Identifier) can be transmitted through PDCCH (Physical Downlink Control Channel), MPDCCH (MTC PDCCH), or NPDCCH (a narrowband PDCCH) (which addresses the paging message for NB-IoT).

In P-RNTI transmitted through MPDCCH, PO may indicate a start subframe of MPDCCH repetition. In the case of the P-RNTI transmitted through the NPDCCH, when the subframe determined by the PO is not a valid NB-IoT downlink subframe, the PO may indicate the start subframe of the NPDCCH repetition. Therefore, the first valid NB-IoT downlink subframe after PO is the start subframe of NPDCCH repetition.

One paging frame (PF) is one radio frame that may include one or a plurality of paging occasions. When DRX is used, the UE only needs to monitor one PO per DRX cycle. One paging narrow band (PNB) is one narrow band in which the UE performs paging message reception. PF, PO, and PNB may be determined based on DRX parameters provided in system information.

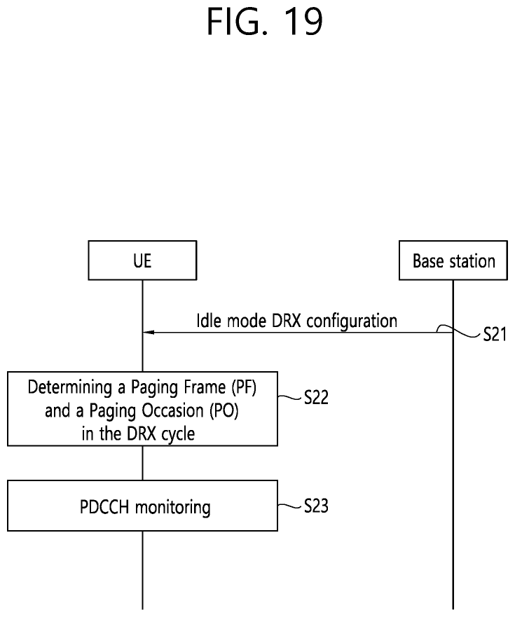

FIG. 19 is a flowchart illustrating an example of performing an idle mode DRX operation.

According to FIG. 19, the UE may receive idle mode DRX configuration information from the base station through higher layer signaling (e.g., system information) (S21).

The UE may determine a Paging Frame (PF) and a Paging Occasion (PO) to monitor the PDCCH in the paging DRX cycle based on the idle mode DRX configuration information (S22). In this case, the DRX cycle may include an on-duration and a sleep duration (or an opportunity of DRX).

The UE may monitor the PDCCH in the PO of the determined PF (S23). Here, for example, the UE monitors only one subframe (PO) per paging DRX cycle. In addition, when the UE receives the PDCCH scrambled by the P-RNTI during the on-duration (i.e., when paging is detected), the UE may transition to the connected mode and may transmit/receive data to/from the base station.

<Connected Mode DRX(C-DRX)>

C-DRX means DRX applied in the RRC connection state. The DRX cycle of C-DRX may consist of a short DRX cycle and/or a long DRX cycle. Here, a short DRX cycle may correspond to an option.

When C-DRX is configured, the UE may perform PDCCH monitoring for the on-duration. If the PDCCH is successfully detected during PDCCH monitoring, the UE may operate (or run) an inactive timer and maintain an awake state. Conversely, if the PDCCH is not successfully detected during PDCCH monitoring, the UE may enter the sleep state after the on-duration ends.

When C-DRX is configured, a PDCCH reception occasion (e.g., a slot having a PDCCH search space) may be configured non-contiguously based on the C-DRX configuration. In contrast, if C-DRX is not configured, a PDCCH reception occasion (e.g., a slot having a PDCCH search space) may be continuously configured in the present disclosure.

On the other hand, PDCCH monitoring may be limited to a time interval set as a measurement gap (gap) regardless of the C-DRX configuration.

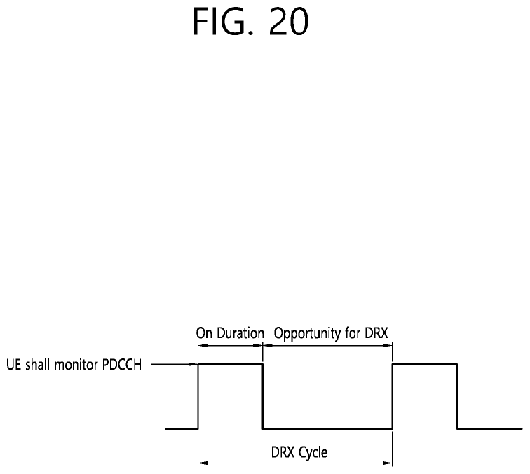

FIG. 20 illustrates a DRX cycle.

Referring to FIG. 20, a DRX cycle includes “On Duration” and “Opportunity for DRX”. The DRX cycle defines a time interval in which “On Duration” is periodically repeated. “On Duration” represents a time period that the UE monitors to receive the PDCCH. When DRX is configured, the UE performs PDCCH monitoring during “On Duration”. If there is a PDCCH successfully detected during PDCCH monitoring, the UE operates an inactivity timer and maintains an awake state. Meanwhile, if there is no PDCCH successfully detected during PDCCH monitoring, the UE enters a sleep state after the “On Duration” is over. Accordingly, when DRX is configured, PDCCH monitoring/reception may be discontinuously performed in the time domain in performing the procedures and/or methods described/suggested above. For example, when DRX is configured, in the present disclosure, a PDCCH reception occasion (e.g., a slot having a PDCCH search space) may be set discontinuously according to the DRX configuration. Meanwhile, when DRX is not configured, PDCCH monitoring/reception may be continuously performed in the time domain in performing the procedure and/or method described/proposed above. For example, when DRX is not configured, a PDCCH reception occasion (e.g., a slot having a PDCCH search space) may be continuously set in the present disclosure. Meanwhile, regardless of DRX configuration, PDCCH monitoring may be restricted in a time period set as a measurement gap.

Table 6 shows a UE procedure related to the DRX (RRC_CONNECTED state). Referring to Table 6, DRX configuration information is received through higher layer (e.g., RRC) signaling, and DRX ON/OFF is controlled by a DRX command of the MAC layer. When DRX is configured, the UE may discontinuously perform PDCCH monitoring in performing the procedure and/or method described/proposed in the present disclosure.

TABLE 6

| | Type of signals | UE procedure |
|---|---|---|
| 1^{st} step | RRC signalling | Reception of DRX configuration |
| | (MAC-CellGroupConfig) | information |
| 2^{nd} Step | MAC CE | Reception of DRX command |
| | ((Long) DRX command | |
| | MAC CE) | |
| 3^{rd} Step | — | Monitor a PDCCH during an |
| | | ‘on-duration’ of a DRX cycle) |

MAC-CellGroupConfig may include configuration information required to set a medium access control (MAC) parameter for a cell group. MAC-CellGroupConfig may also include configuration information on DRX. For example, MAC-CellGroupConfig may include information as follows in defining DRX.
Value of drx-OnDurationTimer: It defines a length of a start interval of a DRX cycle.
Value of drx-InactivityTimer: It defines a length of a time interval in which the UE is awake after a PDCCH occasion in which the PDCCH indicating initial UL or DL data is detected
Value of drx-HARQ-RTT-TimerDL: It defines a length of a maximum time interval until DL retransmission is received, after initial DL transmission is received.
Value of drx-HARQ-RTT-TimerUL: It defines a length of a maximum time interval until a grant for UL retransmission is received, after a grant for UL initial transmission is received.
drx-LongCycleStartOffset: It defines a time length and a start point of a DRX cycle
drx-ShortCycle (optional): It defines a time length of a short DRX cycle

Here, if any one of drx-OnDurationTimer, drx-InactivityTimer, drx-HARQ-RTT-TimerDL, drx-HARQ-RTT-TimerUL is in operation, the UE performs PDCCH monitoring at every PDCCH occasion while maintaining an awake state.

Hereinafter, a 6G system will be described. Here, the 6G system may be a next-generation communication system after the 5G system or the NR system.

6G systems are aimed at (i) very high data rates per device, (ii) very large number of connected devices, (iii) global connectivity, (iv) very low latency, and (v) lower energy consumption of battery-free IoT devices, (vi) ultra-reliable connection, (vii) connected intelligence with machine learning capabilities, etc. The vision of 6G systems can be four aspects: intelligent connectivity, deep connectivity, holographic connectivity, and ubiquitous connectivity, and the 6G system can satisfy the requirements shown in Table 7 below. That is, Table 7 is a table showing an example of requirements for a 6G system.

TABLE 7

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

A 6G system may have key factors such as enhanced mobile broadband (eMBB), ultra-reliable low latency communications (URLC), massive machine-type communication (mMTC), AI integrated communication, Tactile internet, High throughput, High network capacity, High energy efficiency, Low backhaul and access network congestion and enhanced data security.

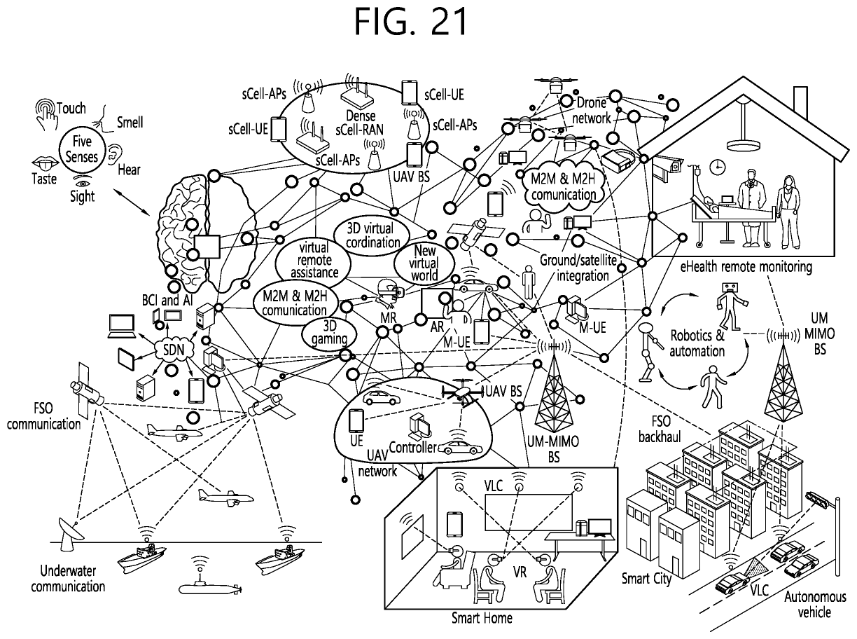

FIG. 21 shows an example of a communication structure that can be provided in a 6G system.

6G systems are expected to have 50 times higher simultaneous wireless communication connectivity than 5G wireless communication systems. URLLC, a key feature of 5G, will become even more important in 6G communications by providing end-to-end latency of less than 1 ms. The 6G system will have much better volume spectral efficiency as opposed to the frequently used area spectral efficiency. 6G systems can provide very long battery life and advanced battery technology for energy harvesting, so mobile devices will not need to be charged separately in 6G systems. New network characteristics in 6G may be as follows.
Satellites integrated network: 6G is expected to be integrated with satellites to serve the global mobile population. Integration of terrestrial, satellite and public networks into one wireless communication system is critical for 6G.
Connected intelligence: Unlike previous generations of wireless communications systems, 6G is revolutionary and will update the evolution of wireless from “connected things” to “connected intelligence.” AI can be applied at each step of the communication procedure (or each procedure of signal processing to be described later).
Seamless integration wireless information and energy transfer: 6G wireless networks will transfer power to charge the batteries of devices such as smartphones and sensors. Therefore, wireless information and energy transfer (WIET) will be integrated.
Ubiquitous super 3D connectivity: Access to networks and core network capabilities of drones and very low Earth orbit satellites will make super 3D connectivity in 6G ubiquitous.

In the new network characteristics of 6G as above, some general requirements may be as follows.
Small cell networks: The idea of small cell networks has been introduced to improve received signal quality resulting in improved throughput, energy efficiency and spectral efficiency in cellular systems. As a result, small cell networks are an essential feature of 5G and Beyond 5G (5 GB) and beyond communication systems. Therefore, the 6G communication system also adopts the characteristics of the small cell network.
Ultra-dense heterogeneous network: Ultra-dense heterogeneous networks will be another important feature of 6G communication systems. Multi-tier networks composed of heterogeneous networks improve overall QoS and reduce costs.
High-capacity backhaul: A backhaul connection is characterized by a high-capacity backhaul network to support high-capacity traffic. High-speed fiber and free space optical (FSO) systems may be possible solutions to this problem.
Radar technology integrated with mobile technology: High-precision localization (or location-based service) through communication is one of the features of 6G wireless communication systems. Thus, radar systems will be integrated with 6G networks.
Softwarization and virtualization: Softwarization and virtualization are two important features fundamental to the design process in 5 GB networks to ensure flexibility, reconfigurability and programmability. In addition, billions of devices can be shared in a shared physical infrastructure.

Hereinafter, artificial intelligence (AI) among the core implementation technologies of the 6G system will be described.

The most important and newly introduced technology for the 6G system is AI. AI was not involved in the 4G system. 5G systems will support partial or very limited AI. However, the 6G system will be AI-enabled for full automation. Advances in machine learning will create more intelligent networks for real-time communication in 6G. Introducing AI in communications can simplify and enhance real-time data transmission. AI can use a number of analytics to determine how complex target tasks are performed. In other words, AI can increase efficiency and reduce processing delays.

Time-consuming tasks such as handover, network selection, and resource scheduling can be performed instantly by using AI. AI can also play an important role in machine-to-machine, machine-to-human and human-to-machine communications. In addition, AI can be a rapid communication in BCI (Brain Computer Interface). AI-based communication systems can be supported by metamaterials, intelligent structures, intelligent networks, intelligent devices, intelligent cognitive radios, self-sustaining wireless networks, and machine learning.

Recently, attempts have been made to integrate AI with wireless communication systems. However, it has been focused on the field of application layer, network layer, and in particular, radio resource management and allocation using deep learning. However, such research is gradually developing into a MAC layer and a physical layer, and in particular, attempts are being made to combine deep learning with wireless transmission in the physical layer. For fundamental signal processing and communication mechanisms, AI-based physical layer transmission means applying signal processing and communication mechanisms based on AI drivers rather than traditional communication frameworks. For example, it may include deep learning-based channel coding and decoding, deep learning-based signal estimation and detection, deep learning-based MIMO mechanism, AI-based resource scheduling (scheduling) and allocation.

Machine learning may be used for channel estimation and channel tracking, and may be used for power allocation, interference cancellation, and the like in a downlink (DL) physical layer. Machine learning can also be used for antenna selection, power control, symbol detection, and the like in a MIMO system.

However, application of a deep neural network (DNN) for transmission in a physical layer may have the following problems.

AI algorithms based on deep learning require a lot of training data to optimize training parameters. However, due to limitations in acquiring data in a specific channel environment as training data, a lot of training data is used offline. This is because static training on training data in a specific channel environment may cause a contradiction between dynamic characteristics and diversity of a radio channel.

In addition, current deep learning mainly targets real signals. However, the signals of the physical layer of wireless communication are complex signals. Further research is needed on a neural network that detects complex domain signals in order to match characteristics of wireless communication signals.

Hereinafter, machine learning will be described in more detail.

Machine learning refers to a set of actions that train a machine to create a machine that can do tasks that humans can or cannot do. Machine learning requires data and a learning model. In machine learning, data learning methods can be largely classified into three types: supervised learning, unsupervised learning, and reinforcement learning.

Neural network training is aimed at minimizing errors in the output. Neural network training repeatedly inputs training data to the neural network, calculates the output of the neural network for the training data and the error of the target, and backpropagates the error of the neural network from the output layer of the neural network to the input layer in a direction to reduce the error and to update the weight of each node in the neural network.

Supervised learning uses training data in which correct answers are labeled in the training data, and unsupervised learning may not have correct answers labeled in the training data. That is, for example, training data in the case of supervised learning related to data classification may be data in which a category is labeled for each training data. Labeled training data is input to the neural network, and an error may be calculated by comparing the output (category) of the neural network and the label of the training data. The calculated error is back-propagated in a reverse direction (i.e., from the output layer to the input layer) in the neural network, and the connection weight of each node of each layer of the neural network may be updated according to the back-propagation. The amount of change in the updated connection weight of each node may be determined according to a learning rate. The neural network's computation of input data and backpropagation of errors can constitute a learning cycle (epoch). The learning rate may be applied differently according to the number of iterations of the learning cycle of the neural network. For example, a high learning rate may be used in the early stages of neural network training to increase efficiency by allowing the neural network to quickly obtain a certain level of performance, and a low learning rate may be used in the late stage to increase accuracy.

Depending on the characteristics of the data, the learning method may be different. For example, in the communication system, if the purpose is to accurately predict the data transmitted by the transmitting end at the receiving end, it is preferable to perform learning using supervised learning rather than unsupervised learning or reinforcement learning.

The learning model corresponds to the human brain, and the most basic linear model can be considered. However, a paradigm of machine learning that uses a neural network structure of high complexity, such as artificial neural networks, as a learning model is called deep learning.

The neural network core used as a learning method is largely deep neural networks (DNN), convolutional deep neural networks (CNN), and recurrent Boltzmann Machine (RNN) methods.

An artificial neural network is an example of connecting several perceptrons.

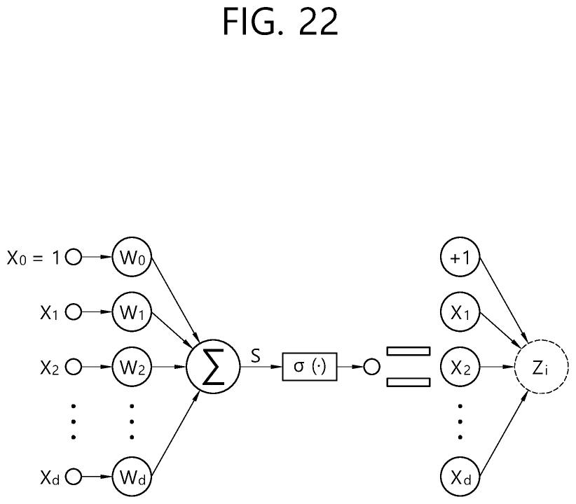

FIG. 22 shows an example of a perceptron structure.

Referring to FIG. 22, when the input vector x=(x₁, x₂, . . . , x_{d}) is input, each component is multiplied by the weight (W₁, W₂, . . . , W_{d}), and after summing the results, the activation function σ(·) is applied. This entire process is called a perceptron. The huge artificial neural network structure may extend the simplified perceptron structure shown in FIG. 22 and apply input vectors to different multi-dimensional perceptrons. For convenience of description, an input value or an output value is referred to as a node.

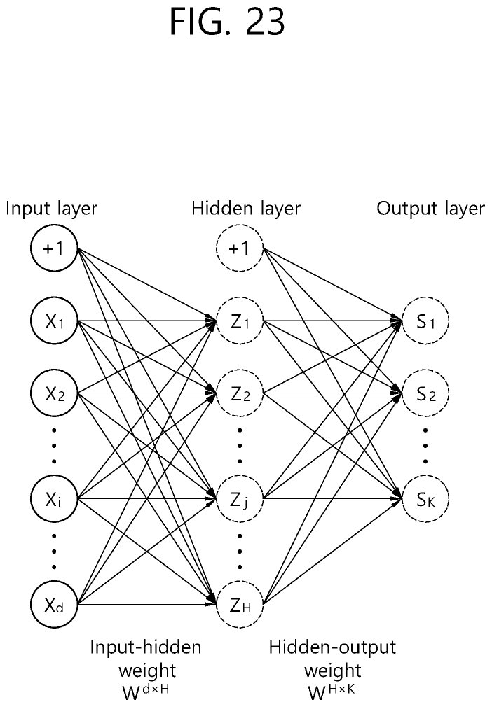

Meanwhile, the perceptron structure shown in FIG. 22 can be described as being composed of a total of three layers based on input values and output values. An artificial neural network in which there are H number of (d+1) dimensional perceptrons between the first layer and the second layer and K number of (H+1) dimensional perceptrons between the second layer and the third layer can be expressed as shown in FIG. 23.

FIG. 23 shows an example of a multi-perceptron structure.

The layer where the input vector is located is called the input layer, the layer where the final output value is located is called the output layer, and all layers located between the input layer and the output layer are called hidden layers. In the example of FIG. 23, three layers are disclosed, but when counting the number of actual artificial neural network layers, since the count excludes the input layer, it can be viewed as a total of two layers. The artificial neural network is composed of two-dimensionally connected perceptrons of basic blocks.

The above-described input layer, hidden layer, and output layer can be jointly applied to various artificial neural network structures such as CNN and RNN, which will be described later, as well as multi-layer perceptrons. As the number of hidden layers increases, the artificial neural network becomes deeper, and a machine learning paradigm that uses a sufficiently deep artificial neural network as a learning model is called deep learning. In addition, the artificial neural network used for deep learning is called a deep neural network (DNN).

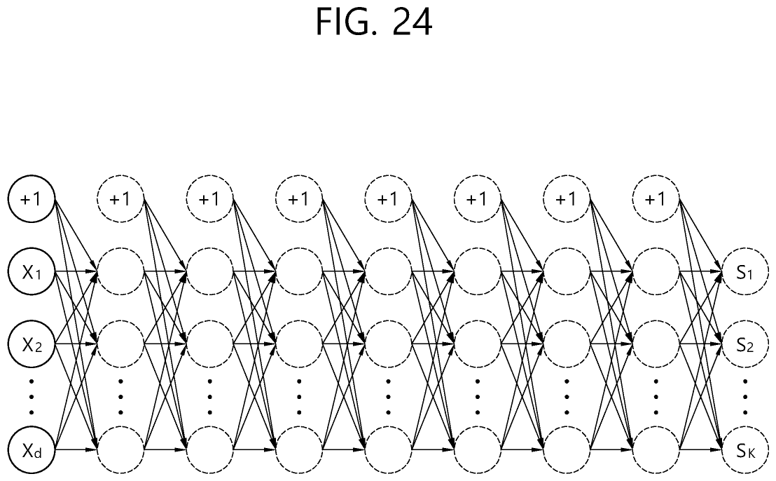

FIG. 24 shows an example of a deep neural network.

The deep neural network shown in FIG. 24 is a multilayer perceptron composed of 8 hidden layers and 8 output layers. The multilayer perceptron structure is expressed as a fully-connected neural network. In a fully-connected neural network, there is no connection relationship between nodes located on the same layer, and there is a connection relationship only between nodes located on adjacent layers. DNN has a fully-connected neural network structure and is composed of a combination of multiple hidden layers and activation functions, so it can be usefully applied to identify the correlation characteristics between inputs and outputs. Here, the correlation characteristics may mean a joint probability of input and output.

On the other hand, depending on how a plurality of perceptrons are connected to each other, various artificial neural network structures different from the aforementioned DNN can be formed.

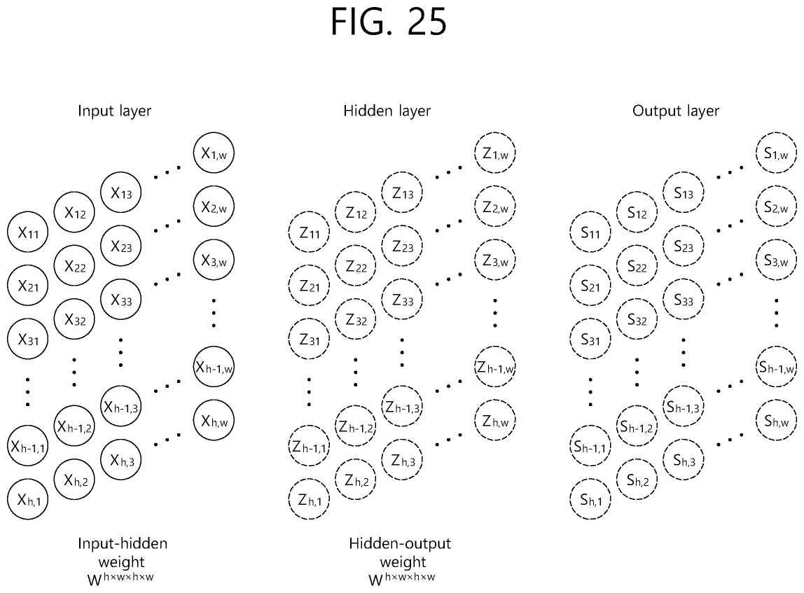

FIG. 25 shows an example of a convolutional neural network.

In DNN, nodes located inside one layer are arranged in a one-dimensional vertical direction. However, referring to FIG. 25, it can be assumed that the nodes are two-dimensionally arranged with w nodes horizontally and h nodes vertically. In this case, since a weight is added for each connection in the connection process from one input node to the hidden layer, a total of h*w weights must be considered. Since there are h*w nodes in the input layer, a total of h²w² weights are required between two adjacent layers.

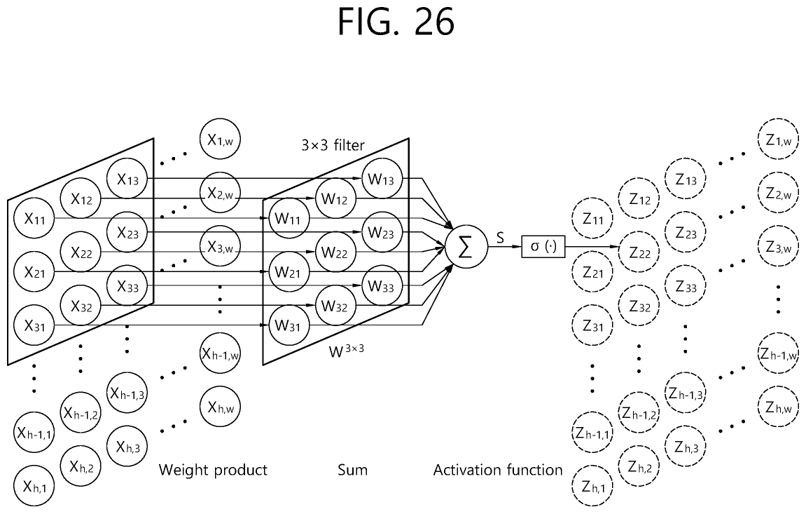

FIG. 26 shows an example of a filter operation in a convolutional neural network.

The convolutional neural network of FIG. 25 has a problem in that the number of weights increases exponentially according to the number of connections. Therefore, instead of considering the connection of all modes between adjacent layers, it is assumed that a filter having a small size is present and a weighted sum and an activation function operation are performed on a portion where the filters overlap as shown in FIG. 26.

One filter has weights corresponding to the size of the filter. In addition, learning of weights may be performed so that a specific feature of an image may be extracted as a factor and output. In FIG. 26, a 3 by 3 size filter is applied to the 3 by 3 area at the top left of the input layer, and an output value obtained by performing a weighted sum and activation function operation on a corresponding node is stored in z₂₂.

The filter scans the input layer while moving horizontally and vertically at regular intervals, performs weighted sum and activation function calculations, and places the output value at the position of the current filter. Since this operation method is similar to a convolution operation on an image in the field of computer vision, a deep neural network having such a structure is called a convolutional neural network (CNN). A hidden layer generated as a result of the convolution operation is called a convolutional layer. Also, a neural network having a plurality of convolutional layers is referred to as a deep convolutional neural network (DCNN).

In the convolution layer, the number of weights may be reduced by calculating a weighted sum by including only nodes located in a region covered by the filter in the node where the current filter is located. This allows one filter to be used to focus on features for a local area. Accordingly, CNN can be effectively applied to image data processing in which a physical distance in a 2D area is an important criterion. Meanwhile, in the CNN, a plurality of filters may be applied immediately before the convolution layer, and a plurality of output results may be generated through a convolution operation of each filter.

Meanwhile, there may be data whose sequence characteristics are important according to data attributes. It is called Recurrent Neural Network which is a structure that applies a method to an artificial neural network in which an element of a data sequence is input one by one at each timestep, and an output vector (hidden vector) of a hidden layer output at a specific time point is input together with the next element in the sequence considering the length variability and precedence relationship of these sequence data.

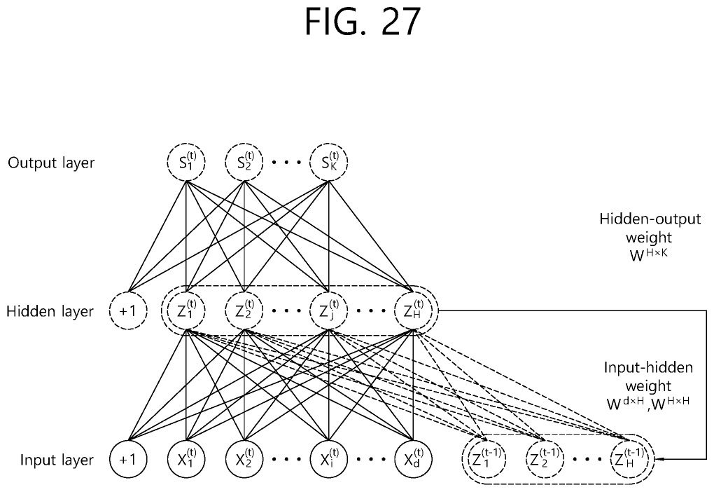

FIG. 27 shows an example of a neural network structure in which a recurrent loop exists.

Referring to FIG. 27, in a recurrent neural network (RNN), in the process of inputting an element (x₁(t), x₂(t), . . . , x_{d}(t)) at a point in time t on a data sequence into a fully connected neural network, at the previous time point t−1, the weighted sum and activation function are applied by inputting the hidden vectors (z₁(t−1), z₂(t−1), . . . , z_{H}(t−1)) together. The reason why the hidden vector is transmitted to the next time point in this way is that information in the input vector at previous time points is regarded as being accumulated in the hidden vector of the current time point.

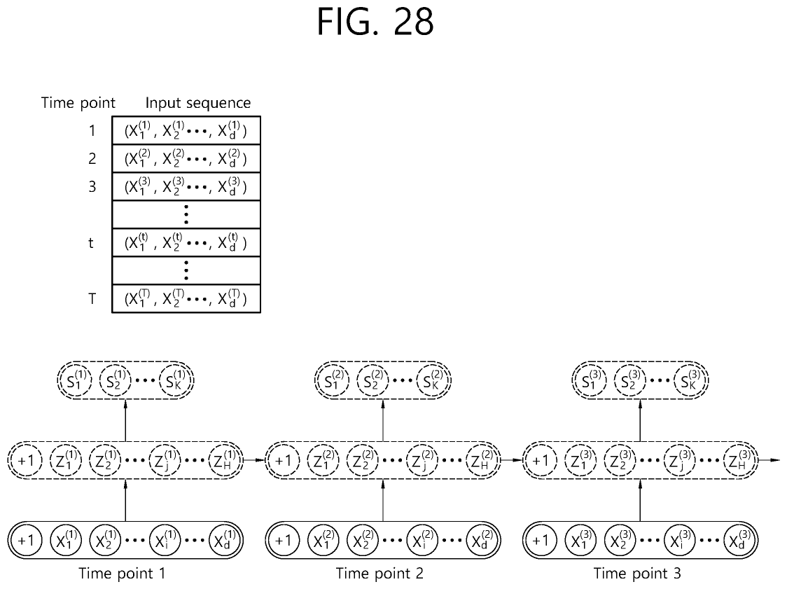

FIG. 28 illustrates an example of an operating structure of a recurrent neural network.

Referring to FIG. 28, the recurrent neural network operates in a predetermined sequence of views with respect to an input data sequence.

The vector (z₁(2), z₂(2), . . . , z_{H}(2)) of the hidden layer is determined through a weighted sum and an activation function by inputting the hidden vector (z₁(1), z₂(1), . . . , z_{H}(1)), which is a hidden vector when the input vector (x₁(t), x₂(t), . . . , x_{d}(t)) at time point 1 is input to the recurrent neural network, together with the input vector (x₁(2), x₂(2), . . . , x_{d}(2)) at time point 2. This process is repeatedly performed until time point 2, time point 3, . . . time point T.

Meanwhile, when a plurality of hidden layers are arranged in a recurrent neural network, it is referred to as a deep recurrent neural network (DRNN). Recurrent neural networks are designed to be usefully applied to sequence data (e.g., natural language processing).

As a neural network core used as a learning method, in addition to DNN, CNN, and RNN, various deep learning techniques such as Restricted Boltzmann Machine (RBM), deep belief networks (DBN), and Deep Q-Network can be included. It can be applied to fields such as computer vision, voice recognition, natural language processing, and voice/signal processing.

Hereinafter, a neural network will be described.

A neural network is a machine learning model modeled after the human brain. What computers can do well is the four arithmetic operations made up of 0 and 1. Thanks to the development of technology, computers can now process much more arithmetic operations in a faster time and with less power than before. On the other hand, humans cannot perform arithmetic operations as fast as computers. That's because the human brain isn't built to handle only fast arithmetic. However, in order to process something beyond it such as cognition, natural language processing, etc., you need to be able to do things beyond the four arithmetic operations, but current computers cannot process those things to the level that the human brain can. Therefore, in areas such as natural language processing and computer vision, if we can create systems that perform similarly to humans, great technological advances can occur. That's why, before chasing after human ability, you will be able to come up with an idea to imitate the human brain first. A neural network is a simple mathematical model built around this motivation. We already know that the human brain consists of an enormous number of neurons and the synapses that connect them. In addition, depending on how each neuron is activated, other neurons will also take actions such as being activated or not activated. Then, based on these facts, it is possible to define the following simple mathematical model.

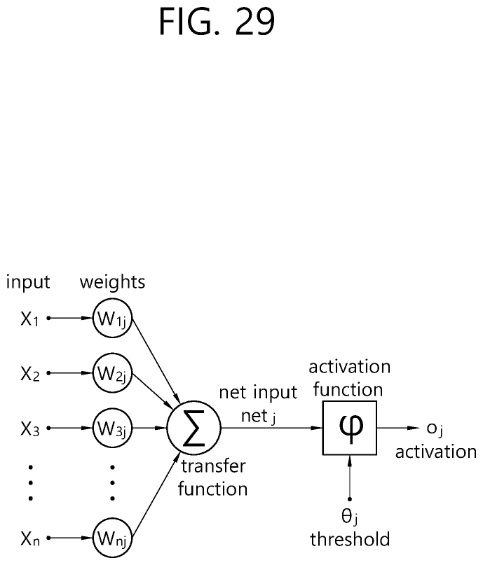

FIG. 29 shows an example of a neural network model.

First, it is possible to create a network in which each neuron is a node and the synapse connecting the neurons is an edge. Since the importance of each synapse may be different, if a weight is separately defined for each edge, a network can be created in the form shown in FIG. 29. Usually, neural networks are directed graphs. That is, information propagation is fixed in one direction. If an undirected edge is provided or the same directed edge is given in both directions, information propagation occurs recursively, resulting in a slightly complicated result. This case is called a recurrent neural network (RNN), and since it has an effect of storing past data, it is widely used when processing sequential data such as voice recognition. The multi-layer perceptron (MLP) structure is a directed simple graph, and there is no connection between the same layers. That is, there are no self-loops and parallel edges, edges exist only between layers, and only layers adjacent to each other have edges. That is, there is no edge directly connecting the first layer to the fourth layer. In the following, these MLPs are assumed unless there is a specific mention of the layer. In this case, information propagation occurs only forward, so such a network is also called a feed-forward network.

In the actual brain, different neurons are activated, and the result is passed on to the next neuron, and as the result is passed on, information is processed according to the way in which the neuron that makes the final decision is activated. If we convert this method into a mathematical model, it may be possible to express activation conditions for input data as a function. This is defined as an activation function or activate function. The simplest example of an activation function would be a function that adds up all incoming input values and then sets a threshold so that if this value exceeds a certain value, it is activated and if it does not exceed that value, it is deactivated. There are several types of activation functions that are commonly used, and some are introduced below. For convenience, it is defined as t=Σᵢ(wᵢxᵢ). For reference, in general, not only weights but also biases should be considered. In this case, t=Σᵢ(wᵢxᵢ)+bᵢ, but in this specification, the bias is omitted because it is almost the same as the weight. For example, if x₀ whose value is always 1 is added, since w₀ becomes a bias, it is okay to assume a virtual input and treat the weight and bias as the same.
Sigmoid function: f(t)=1/(1+e^{-t})
hyperbolic tanh function: f(t)=(1−e^{-t})/(1+e^{-t})
Absolute function: f(t)=∥t∥
Rectified Linear Unit function (ReLU function): f(0=max(0, t)

Therefore, the model first defines the shape of a network composed of nodes and edges, and defines an activation function for each node. The weight of the edge plays the role of a parameter adjusting the model determined in this way, and finding the most appropriate weight can be a goal when training the mathematical model.

Hereinafter, it is assumed that all parameters are determined and how the neural network infers the result will be described. A neural network first determines the activation of the next layer for a given input, and then uses it to determine the activation of the next layer. In this way, decisions are made up to the last layer, and inference is determined by looking at the results of the last decision layer.

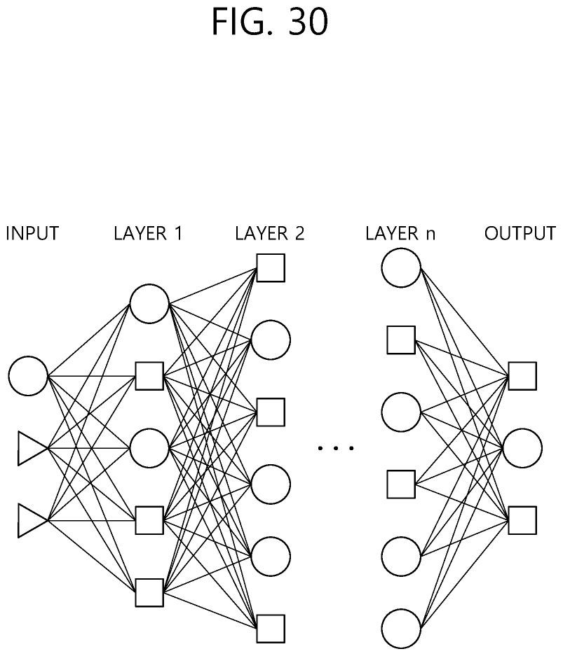

FIG. 30 shows an example of an activated node in a neural network.

Nodes circled in FIG. 30 represent activated nodes. For example, in the case of classification, as many decision nodes as the number of classes the user wants to classify can be created in the last layer, and then one activated value can be selected.

Since the activation functions of the neural network are non-linear and are complexly entangled while forming layers with each other, weight optimization of the neural network may be non-convex optimization. Therefore, it is impossible to find a global optimum of parameters of a neural network in a general case. Therefore, it is possible to use a method of converging to an appropriate value using the usual gradient descent (GD) method. Any optimization problem can be solved only when a target function is defined. In a neural network, a method of minimizing the value, by calculating a loss function between the target output actually desired in the last decision layer and the estimated output produced by the current network, can be taken. Commonly chosen loss functions include the following functions: Meanwhile, the d-dimensional target output is defined as t=[t₁, . . . , t_{d}] and the estimated output is defined as x=[x₁, . . . , x_{d}]. Various loss functions for optimization can be used, and the following is an example of a representative loss function.

$$Sum of Euclidean loss : {\sum }_{i = 1}^{d} {( {t}_{i} - {x}_{i} )}^{2}$$

$$Softmax loss : - {\sum }_{i = 1}^{d} {t}_{i} log \frac{{e}^{{x}_{j}}}{{\sum }_{j = 1}^{d} {e}^{{x}_{j}}} + ( 1 - {t}_{i} ) log ( 1 - \frac{{e}^{{x}_{j}}}{{\sum }_{j = 1}^{d} {e}^{{x}_{j}}} )$$

$$Cross - entropy loss : {\sum }_{i = 1}^{d} - {t}_{i} log {x}_{i} + ( 1 - {t}_{i} ) log ( 1 - {x}_{i} )$$

If the loss function is given in this way, the gradient can be obtained for the given parameters and then the parameters can be updated using the values.

On the other hand, the backpropagation algorithm is an algorithm that simplifies the gradient calculation by using the chain rule. Parallelization is easy when calculating the gradient of each parameter, and memory efficiency can be increased according to the algorithm design. Therefore, the actual neural network update mainly uses the backpropagation algorithm. In order to use the gradient descent method, it is necessary to calculate the gradient for the current parameter, but if the network becomes complex, it may be difficult to calculate the value immediately. Instead, according to the backpropagation algorithm, first calculate the loss using the current parameters, calculate how much each parameter affects the loss using the chain rule, and update with that value. Accordingly, the backpropagation algorithm can be largely divided into two phases, one is a propagation phase and the other is a weight update phase. In the propagation phase, an error or variation of each neuron is calculated from the training input pattern, and in the weight update phase, the weight is updated using the previously calculated value.

Specifically, in the propagation phase, forward propagation or backpropagation may be performed. Forward propagation computes the output from the input training data and computes the error in each neuron. At this time, since information moves in the order of input neuron-hidden neuron-output neuron, it is called forward propagation. In backpropagation, the error calculated in the output neuron is calculated by using the weight of each edge to determine how much the neurons in the previous layer contributed to the error. At this time, since the information moves in the order of the output neuron-hidden neuron, it is called backpropagation.

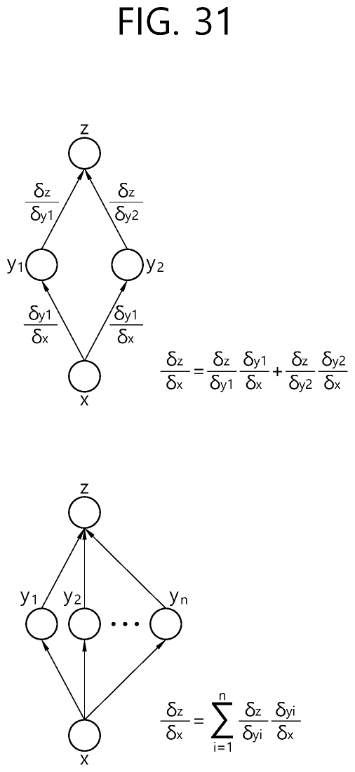

In addition, in the weight update phase, the weights of the parameters are calculated using the chain rule. In this case, the meaning of using the chain rule may mean that the current gradient value is updated using the previously calculated gradient as shown in FIG. 31.

FIG. 31 shows an example of gradient calculation using the chain rule.

In FIG. 31, the purpose is to obtain (δz)/(δx). Instead of calculating the corresponding value directly, the desired value can be calculated using (δz)/(δy), which is the derivative calculated at the y-layer, and (δy)/(δx), which is related only to the y-layer and x. If a parameter x′ exists separately before x, (δz)/(δx′) can be calculated using (δz)/(δx) and (δx′)/(δx). Therefore, what is required in the backpropagation algorithm is the differential value of the variable just before the current parameter to be updated and the value obtained by differentiating the immediately preceding variable with the current parameter. This process is repeated step by step from the output layer. That is, the weight may be continuously updated through the process of output-hidden neuron k, hidden neuron k-hidden neuron k−1, . . . , hidden neuron 2-hidden neuron 1, hidden neuron 1-input.

Computing the gradient updates the parameters using gradient descent. However, in general, the number of input data of a neural network is quite large. Therefore, in order to calculate an accurate gradient, it is sufficient to calculate all gradients for all training data, obtain an accurate gradient using the average of the values, and perform an update once. However, since this method is inefficient, a stochastic gradient descent (SGD) method can be used.

Instead of performing a gradient update by averaging the gradients of all the data (this is called a full batch), SGD creates a mini-batch with some data and calculates the gradient for only one batch and updates the entire parameter. In the case of convex optimization, it has been proven that SGD and GD converge to the same global optimum if certain conditions are satisfied. However, since neural networks are not convex, the conditions for convergence change depending on how they are placed.

Hereinafter, types of neural networks will be described.

First, a convolution neural network (CNN) will be described.

CNN is a kind of neural network mainly used for speech recognition or image recognition. It is configured to process multidimensional array data, and is specialized in processing multidimensional arrays such as color images. Therefore, most techniques using deep learning in the field of image recognition are based on CNN. In the case of a general neural network, image data is processed as it is. That is, since the entire image is considered as one piece of data and accepted as an input, correct performance may not be obtained if the characteristics of the image are not found and the position of the image is slightly changed or distorted. However, CNN processes an image by dividing it into several pieces rather than one piece of data. In this way, even if the image is distorted, partial features of the image can be extracted, resulting in correct performance. CNN can be defined in the following terms.
Convolution: The convolution operation means that one of the two functions f and g is reversed or shifted, and then the multiplication result with the other function is integrated. In the discrete domain, use sum instead of integral.
Channel: means the number of data columns constituting input or output when performing convolution.
Filter or kernel: A function that performs convolution on input data.
Dilation: It means the interval between data when convolution is performed on the data and the kernel. For example, if the dilation is 2, extract one every two of the input data and perform convolution with the kernel.
Stride: It means the interval at which filters/kernels are shifted when performing convolution.
Padding: It means an operation of adding a specific value to input data when performing convolution, and the specific value is usually 0.
Factor map (feature map): It means the output result of performing convolution.

Next, a recurrent neural network (RNN) will be described.

RNN is a type of artificial neural network in which hidden nodes are connected with directed edges to form a directed cycle. It is known as a model suitable for processing data that appears sequentially, such as voice and text, and is an algorithm that has recently been in the limelight along with CNN. Because it is a network structure that can accept inputs and outputs regardless of sequence length, the biggest advantage of RNN is that it can create various and flexible structures as needed.

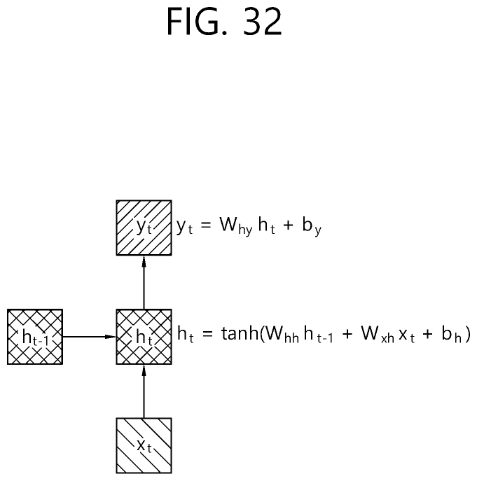

FIG. 32 shows an example of the basic structure of an RNN.

In FIG. 32, h_t (t=1, 2, . . . ) is a hidden layer, x represents an input, and y represents an output. It is known that in RNN, when the distance between the relevant information and the point where the information is used is long, the gradient gradually decreases during backpropagation, resulting in a significant decrease in learning ability. This is called the vanishing gradient problem. The structures proposed to solve the vanishing gradient problem are long-short term memory (LSTM) and gated recurrent unit (GRU).

Hereinafter, an autoencoder will be described.

Various attempts have been made to apply neural networks to communication systems. Among them, attempts to apply to the physical layer are mainly considering optimizing a specific function of a receiver. For example, performance can be improved by configuring a channel decoder as a neural network. Alternatively, performance may be improved by implementing a MIMO detector as a neural network in a MIMO system having a plurality of transmit/receive antennas.

Another approach is to construct both a transmitter and a receiver as a neural network and perform optimization from an end-to-end point of view to improve performance. This is called an autoencoder.

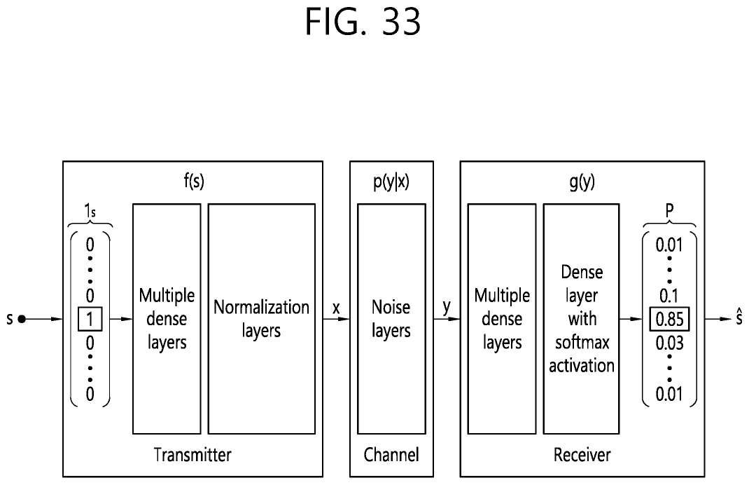

FIG. 33 shows an example of an autoencoder.

Referring to FIG. 33, an input signal sequentially proceeds to a transmitter, a channel, and a receiver. Here, as an example, when the input signal is a 5-bit signal, the 5-bit signal can be expressed in 32 ways, which can be expressed as a vector of one row or one column having 32 elements. When the vector passes through the transmitter and the channel and reaches the receiver, the receiver can obtain information according to the contents of the detected vector.

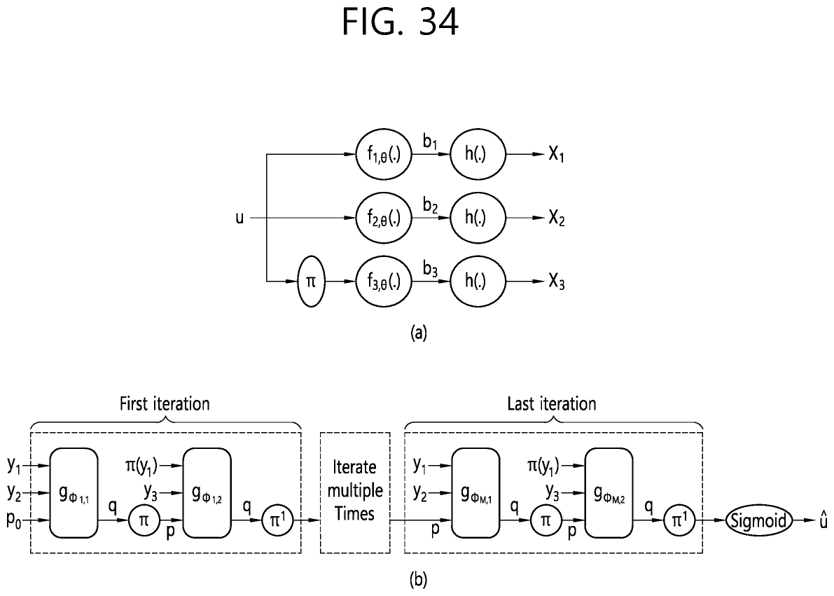

The autoencoder structure of FIG. 33 has a problem in which complexity increases exponentially as the input data block size K increases, that is, a curse of dimensionality occurs. In this case, the above problem can be solved when designing a structured transmitter. This is called a turbo autoencoder (turbo AE), and the encoder and decoder structures of the turbo autoencoder are shown in FIG. 34.

FIG. 34 shows an example of an encoder structure and a decoder structure of a turbo autoencoder. Specifically, (a) of FIG. 34 shows the structure of a neural network encoder, and (b) of FIG. 34 shows the structure of a neural network decoder.

(a) of FIG. 34 shows an encoder structure with a code rate of 1/3, where f_{i,θ} represents a neural network and h(·) represents a power constraint. Also, π means an interleaver. (b) of FIG. 34 shows the structure of the decoder, employing a method similar to the iterative decoding method of the turbo decoder, and is composed of two sub-decoders for each iterative decoding. Here, g_{0i,j} denotes the j-th sub-decoder at the i-th iteration decoding.

In the following, the proposal of the present disclosure will be described in more detail.

The following drawings are made to explain a specific example of the present specification. Since the names of specific devices or names of specific signals/messages/fields described in the drawings are provided as examples, the technical features of the present specification are not limited to the specific names used in the drawings below.

Since the complexity of the autoencoder exponentially increases as the input data block size increases, the structure shown in FIG. 33 is not suitable for large block size data transmission. The autoencoder structure of FIG. 34 that solves this problem can transmit data of a relatively large block size, but is more complicated than the existing channel coding system. Table 8 below compares the complexity of turbo autoencoders for a block size of 100. FLOP in Table 8 is a floating-point operation number, and EMO represents an elementary math operation. The complexity of neural encoder and neural decoder using CNN/RNN was calculated with FLOP, and the complexity of turbo encoder and turbo decoder was calculated with EMO.

TABLE 8

| | CNN | CNN | RNN | RNN | Turbo | Turbo |
|---|---|---|---|---|---|---|
| Metric | encoder | decoder | encoder | decoder | encoder | decoder |
| FLOP/E | 1.8M | 294.15M | 33.4M | 6.7 G | 104K | 408K |
| MO | | | | | | |
| Weight | 157.4K | 2.45M | 1.14M | 2.71M | N/A | N/A |

Referring to Table 8, the encoder and decoder composed of the neural network have a greater complexity than the turbo encoder and turbo decoder.

Therefore, it is necessary to design an autoencoder with reduced complexity while maintaining performance. Here, the distance characteristic is influenced by the encoder rather than the decoder. The complexity of the neural network encoder and the neural network decoder can be reduced by designing an encoder composed of a neural network to improve a distance or Euclidean distance.

First, the structure of a neural network encoder will be described.

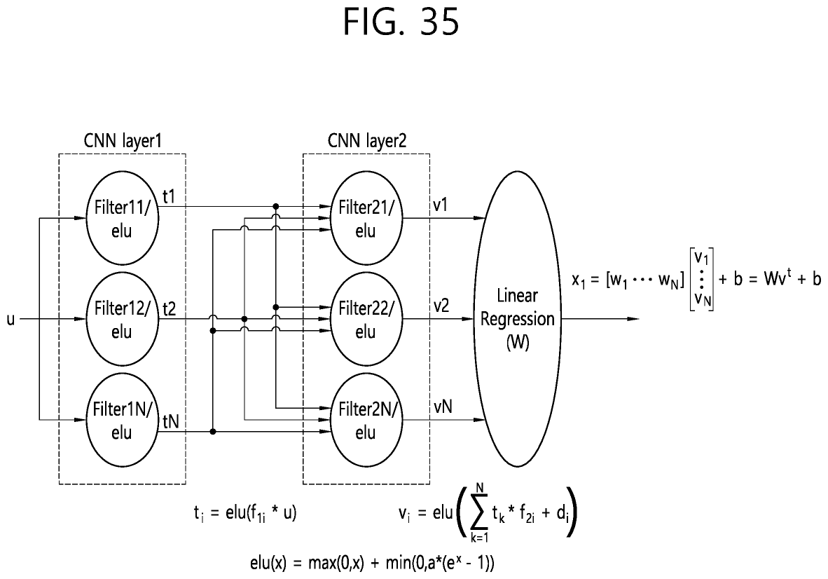

FIG. 35 shows an example in which f_{i, θ} is implemented as a 2-layer CNN in a neural network encoder. Here, an example of the neural network encoder may be shown in (a) of FIG. 34.

Referring to FIG. 35, elu(x) is an activation function of elu(x)=max(0, x)+min(0, a·(e^{x}−1)), and * denotes a convolution operation method. In general, when analyzing encoder characteristics, a minimum distance becomes an important design parameter, which means a minimum value among distances between codewords generated by the encoder. Therefore, a code with good performance can be designed by maximizing the minimum distance of codewords. By employing such a design method, two input data sequences that do not have a large difference in the input data block are considered.

For example, for an input data block of length 10, two input data sequences differing by one bit are u₀=[0, 0, 0, 0, 0, 0, 0, 0, 0, 0] and u₁=[0, 0, 1, 0, 0, 0, 0, 0, 0, 0]. That is, maximizing the minimum distance for input data sequences in which the positions of codewords having different values are not relatively large can improve codeword performance, accordingly, complexity improvement such as reducing the number N of filters and the number of layers in FIG. 35 can be expected.

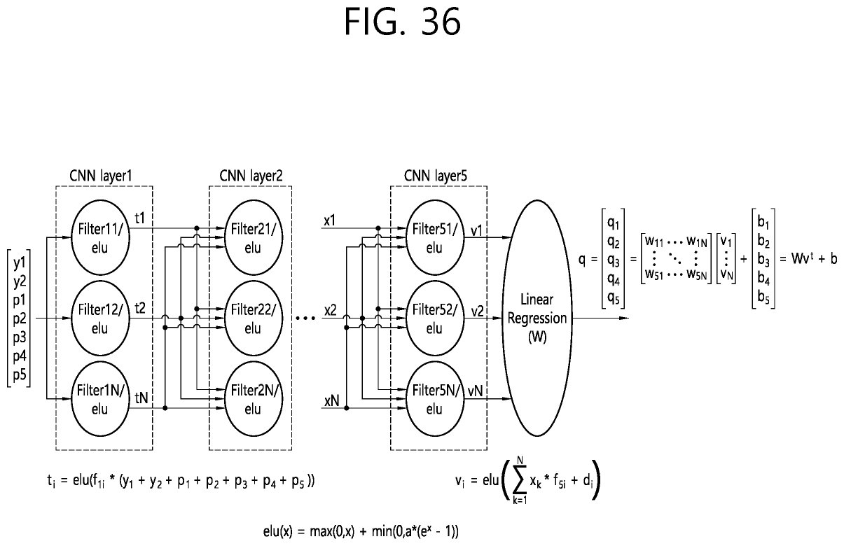

FIG. 36 illustrates an embodiment of g_{0i,j} of a neural network decoder composed of a 5-layer CNN. Here, yᵢ=xᵢ+nᵢ (where i=1, 2, 3), and nᵢ is additive white Gaussian noise (AWGN).

Hereinafter, an embodiment of the neural network encoder structure proposed in this specification will be described.

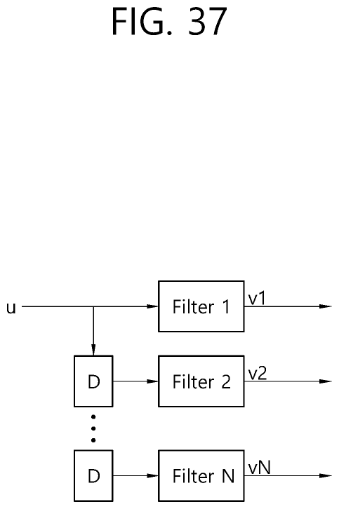

FIG. 37 schematically illustrates the structure of an input end of an embodiment of a neural network encoder for improving distance characteristics.

The structure of FIG. 37 employs the concept of a filter bank, which is an array of filters that separates a signal into several components. Through this, a method of obtaining an effect of an input data sequence having a large weight difference by applying a delay when inputting input data sequences having a small weight difference to a filter is applied. As an example, the delay of FIG. 37 can be applied to the filter input of CNN layer 1 of FIG. 35 to obtain the above effect.

Since the delay is applied to the input of the encoder, the existing decoder structure can be utilized by applying the delay to the input of the CNN layer 1 in the reverse order of FIG. 37 to the decoder. That is, no delay is applied to the input of filter 1N of CNN layer 1 of FIGS. 35, and 1-delay for filter 1(N−1), 2-delay (i.e., twice the 1-delay) for filter 1(N−2), . . . are applied. In this way, when a delay is applied to the input end, the input of the filter can be changed, so that distance characteristics can be improved.

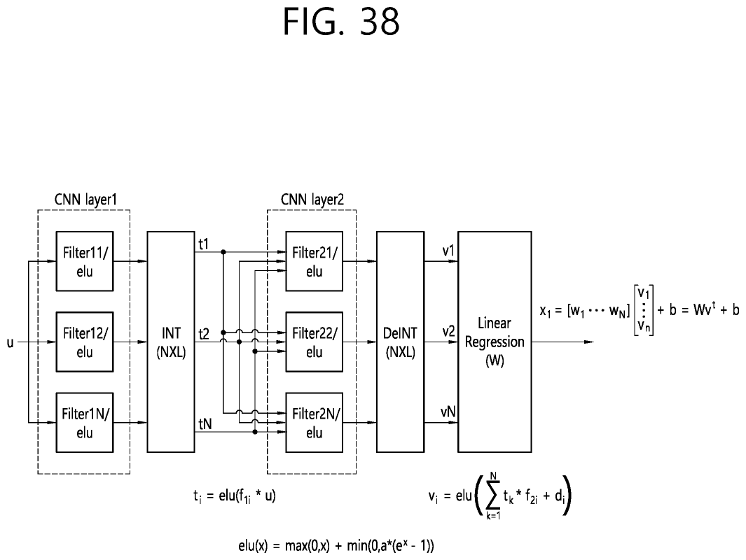

FIG. 38 schematically illustrates the structure of a neural network encoder in which an interleaver is inserted to improve distance characteristics.

Referring to FIG. 38, the delay of the input end of FIG. 36 can be implemented by inserting an interleaver into the filter output end. The neural network encoder structure of FIG. 38 may use the decoder structure of FIG. 36.

Hereinafter, another embodiment of the neural network encoder structure proposed in this specification will be described.

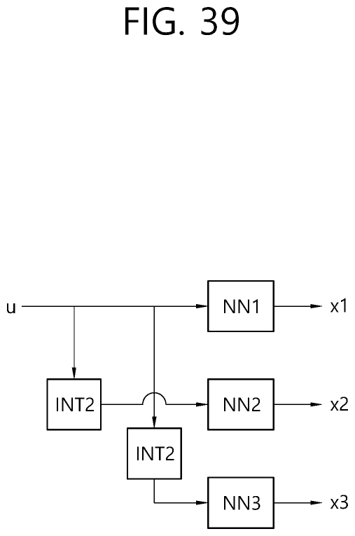

FIG. 39 shows the structure of one embodiment of a neural network encoder with an additional interleaver. Here, INT1 may mean a first interleaver and INT2 may mean a second interleaver, respectively. Also, here, NN1, NN2, and NN3 each represent a neural network, and NN1, NN2, and NN3 may be different types of neural networks. Also, here, π and π⁻¹ may mean interleaving and de-interleaving operations corresponding to INT2, respectively.

Referring to FIG. 39, by additionally inserting an interleaver in the encoder structure of FIG. 34 (a), an effect of increasing weights when input data sequences having a small weight difference are actually input into the neural network encoder can be obtained. The neural network decoder for the neural network encoder structure of FIG. 39 may use a structure in which the deinterleaved signal of INT1 of FIG. 39 is input at y2 in (b) of FIG. 34. Compared to the neural network encoders of FIGS. 34 and 35, according to the structure of FIG. 39, since different interleaver outputs are input to the neural network encoder, distance characteristics can be improved for x₁, x₂, and x₃. In addition, the neural network decoder for the neural network encoder of FIG. 39 may be designed to have a structure opposite to the structure of the neural network encoder of FIG. 39.

Hereinafter, another embodiment of the neural network encoder structure proposed in this specification will be described.

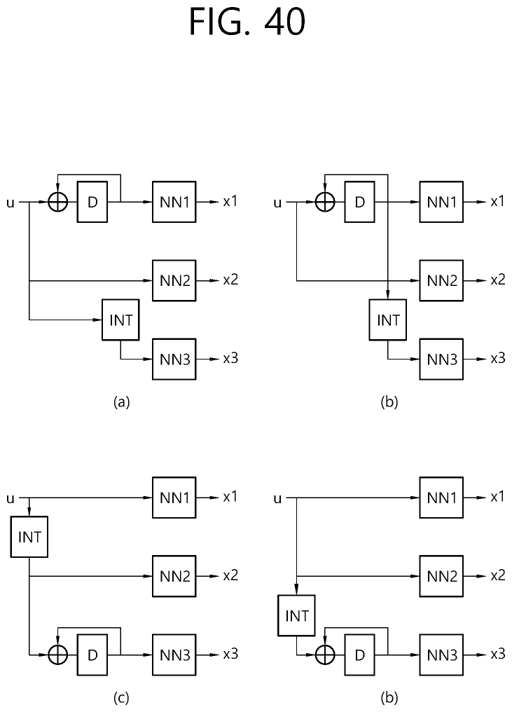

FIG. 40 illustrates an embodiment of a neural network encoder structure in which an accumulator is inserted into an input end. Specifically, the structures of (a) of FIG. 40, (b) of FIG. 40, (c) of FIG. 40, and (d) of FIG. 40 may be considered depending on the position where the accumulator is inserted into the input end.

Referring to FIG. 40, an input data sequence having a large weight difference may be generated from an input data sequence having a small weight difference by inserting an accumulator. In other words, even if the weight difference of the input data sequence is relatively small, the difference value may increase when passing through the accumulator. Therefore, distance characteristics of codewords can be improved. Meanwhile, the neural network encoder structure of FIG. 40 may use the neural network decoder structure of (b) of FIG. 34.

Alternatively, the distance characteristic may be improved by adding an accumulator to the output of the interleaver of FIG. 40.

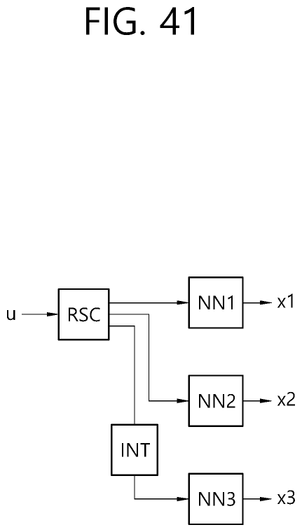

FIG. 41 illustrates an embodiment of a neural network encoder structure concatenated with a recursive systematic convolutional code (RSC code).

Referring to FIG. 41, when generating an input data sequence of a neural network that generates a codeword, a neural network encoder and an RSC code can be concatenated. Here, the distance characteristic can be improved by inserting an accumulator into the interleaver output.

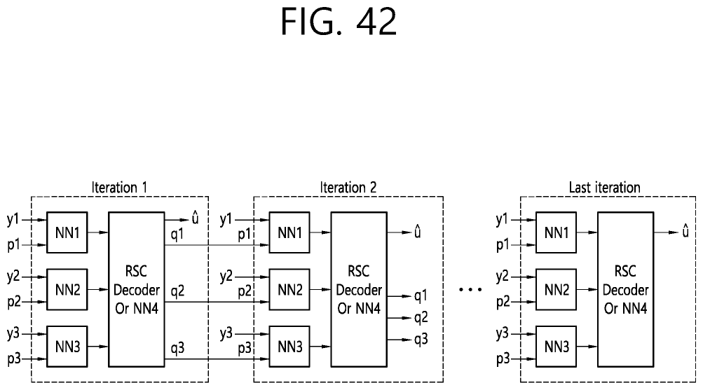

FIG. 42 shows an embodiment of a neural network decoder structure for a neural network encoder structure connected with an RSC code.

The structure of FIG. 41 may consider the structure of a neural network decoder as shown in FIG. 42 in that it is difficult to use the structure of the decoder of (b) of FIG. 34. In other words, since the structure of FIG. 41 inserts the RSC code, the structure of FIG. 42 has a separate decoder for the RSC code.

Hereinafter, another embodiment of the neural network encoder structure proposed in this specification will be described.

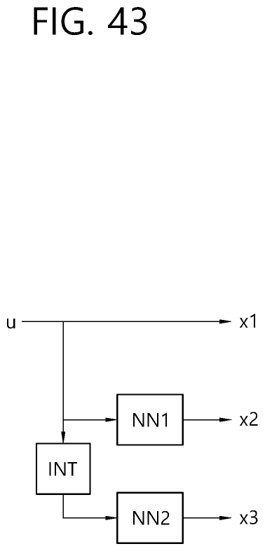

FIG. 43 illustrates an embodiment of a systematic neural network encoder structure.

Referring to FIG. 43, a neural network encoder structure that generates a systematic codeword can be considered, like the encoder structure of a turbo code. Through this, performance improvement can be expected by inputting the tissue codeword to the decoder. The structure of FIG. 43 may utilize the decoder structure of (b) of FIG. 34.

Hereinafter, signaling of neural network parameters will be described.

An autoencoder consists of both a transmitter and a receiver as neural networks. Since the neural network operates after optimizing parameters through training, information on neural network parameters can be signaled from a device in which training is performed to a transmitter or receiver. In the case of downlink, the neural network encoder operates on the side of the base station and the neural network decoder operates on the side of the UE. In the case of uplink, a neural network encoder operates on the UE side and a neural network decoder operates on the base station side.

Hereinafter, an embodiment of training of a neural network proposed in this specification will be described.

When training is performed in a device other than a neural network encoder or a neural network decoder, corresponding neural network parameters may be transmitted from the device in which training is performed to a transmitter in which the neural network encoder operates and a receiver in which the neural network decoder operates. When a device performing training is outside the base station, neural network parameters may be transmitted to the base station or the UE.

For example, parameters of the neural network encoder and the neural network decoder may be transmitted to the base station. At this time, it is possible to use not only a cellular network but also an existing Internet network. After the base station acquires information about parameters of the neural network encoder and neural network decoder, the base station may transmit information about the neural network encoder or the neural network decoder to the UE through a cellular network. That is, the base station may transmit parameter information of the neural network decoder to the UE for downlink data transmission, and the base station may transmit parameter information of the neural network encoder to the UE for uplink data transmission. Here, when transmitting parameter information to the UE, RRC/MAC/L1 signaling may be used.

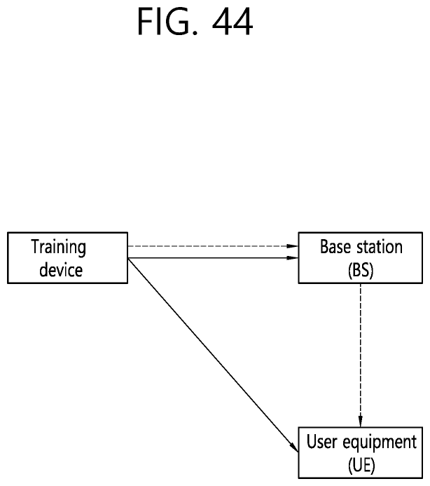

FIG. 44 shows an example of a neural network training method.

Referring to FIG. 44, training of a neural network may be separately performed by a training device, not by a base station or a UE. Here, as shown in the direction of the solid line in FIG. 44, when the training device completes training, the training device may transmit parameter information for the neural network encoder and the neural network decoder to both the base station and the UE. Alternatively, as shown in the direction of the dotted line in FIG. 44, when the training device completes training, the training device transmits parameter information for the neural network encoder and neural network decoder to the base station, and the base station can transmit information necessary for the UE among the parameters to the UE.

Hereinafter, another embodiment of training of a neural network proposed in this specification will be described.

When training is performed in a base station or UE operating as a neural network encoder or neural network decoder, information on neural network parameters should be transmitted to the UE or base station.

For example, when training is performed in a base station, the base station transmits parameter information of a neural network decoder to a UE for downlink data transmission, and the base station transmits parameter information of a neural network encoder to a UE for uplink data transmission. When transmitting to the UE, RRC/MAC/L1 signaling may be used.

That is, when the base station performs training, since the UE performs decoding on downlink data from the viewpoint of downlink data, the base station transmits parameter information related to the neural network decoder to the UE. From the point of view of uplink data, since the UE encodes the uplink data, the base station can transmit parameter information related to the neural network encoder to the UE.

Also, when the UE performs training, the UE transmits parameter information of the neural network encoder to the base station for downlink data transmission, and the UE transmits parameter information of the neural network decoder to the base station for uplink data transmission. When transmitting to the base station, RRC/MAC/L1 signaling may be used.

That is, when the UE performs training, since the base station encodes the downlink data in terms of downlink data, the UE transmits parameter information related to the neural network encoder to the base station. And, since the base station performs decoding on the uplink data from the point of view of uplink data, the UE can transmit parameter information related to the neural network decoder to the base station.

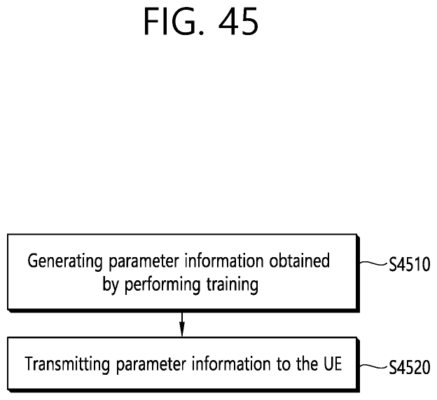

FIG. 45 is a flowchart of another example of a method for training a neural network.

Referring to FIG. 45, the base station generates parameter information obtained by performing training (S4510).

Then, the base station transmits the parameter information to the UE (S4520). Here, the parameter information may inform a first parameter related to a neural network decoder for downlink data and a second parameter related to a neural network encoder for uplink data.

Hereinafter, a signaling method of neural network parameters will be described.

In the structure of the above-described neural network encoder and neural network decoder, the type and number of layers of the neural network, the activation function for each layer, the loss function, the optimization method, the learning rate, the training data set, and the test data set (test data set) information can be transmitted. In addition, weights of neural network encoders or neural network decoders may be transmitted for each corresponding layer. At this time, in addition to the above information, information related to the neural network may be transmitted together.

For example, in the case of CNN, information on the dimension of the convolutional layer, kernel size, dilation, stride, padding, number of input channels, and number of output channels can be transmitted. In addition, in the case of an RNN, information on the RNN type, input shape, output shape, initial input state, output hidden state, and the like can be transmitted.

When generating a training data set and a test data set, a pseudo random sequence generator operating in the same initial state in a transmitter and a receiver may be used. For example, after initializing a gold sequence generator having the same generator polinomial with the same initial state, the same part of the generated sequence may be set as a training data set and a test data set.

Instead of transmitting information such as a weight of a neural network encoder or a neural network decoder, a signaling burden may be reduced by pre-defining the information by a standard, etc. In this case, both the neural network encoder and the neural network decoder can be defined in advance.

Alternatively, only the weight of the neural network encoder may be predefined in a standard or the like and signaled, and the weight of the neural network decoder may be obtained through training in the receiver. At this time, parameters of the neural network decoder capable of obtaining the minimum performance of the neural network decoder may be transmitted to the receiver. In this method, when the receiver is a UE, better performance can be obtained by optimizing the parameters of the neural network decoder when the UE is implemented. Alternatively, a weight value of a neural network encoder may be signaled.

In other words, all types of neural networks and parameters based on the types may be defined in advance, or only some may be defined in advance and the rest may be acquired through training, signaling, and the like.

The claims described herein may be combined in various ways. For example, the technical features of the method claims of the present specification may be combined and implemented as an apparatus, and the technical features of the apparatus claims of the present specification may be combined and implemented as a method. In addition, the technical features of the method claim of the present specification and the technical features of the apparatus claim may be combined to be implemented as an apparatus, and the technical features of the method claim of the present specification and the technical features of the apparatus claim may be combined and implemented as a method.

The methods proposed in this specification can be performed not only by a UE, but also by at least one computer readable medium containing instructions based on being executed by at least one processor and a device (apparatus) set to control a UE and including one or more processors and one or more memories operably connected by the one or more processors and storing instructions, wherein the one or more processors execute the instructions to perform the methods proposed herein. In addition, according to the methods proposed in this specification, it is obvious that an operation by a base station corresponding to an operation performed by a UE can be considered.

Hereinafter, an example of a communication system to which the present disclosure is applied will be described.

Although not limited thereto, the various descriptions, functions, procedures, proposals, methods, and/or operation flowcharts of the present disclosure disclosed in this document may be applied to various fields requiring wireless communication/connection (e.g., 5G) between devices.

Hereinafter, it will be exemplified in more detail with reference to the drawings. In the following drawings/descriptions, the same reference numerals may represent the same or corresponding hardware blocks, software blocks, or functional blocks, unless otherwise indicated.

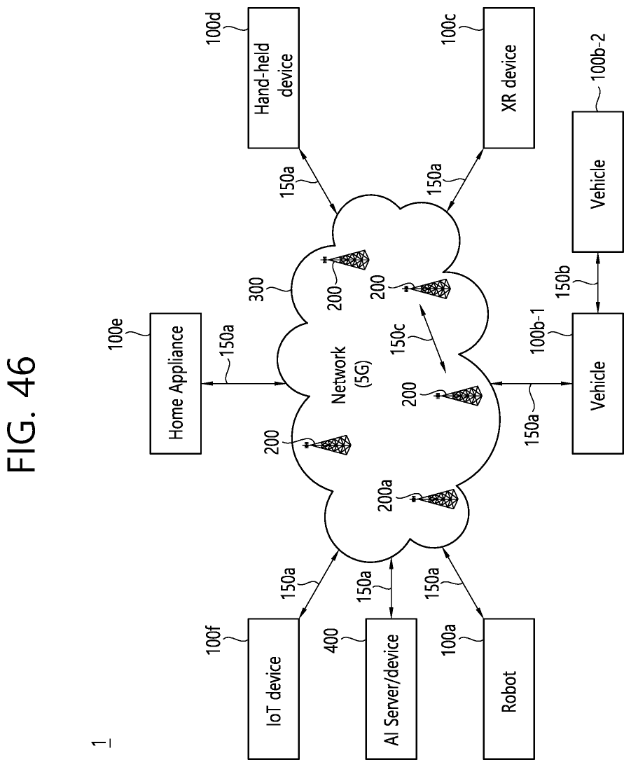

FIG. 46 illustrates a communication system 1 applied to the present disclosure.

Referring to FIG. 46, the communication system 1 applied to the present disclosure includes a wireless device, a base station, and a network. Here, the wireless device refers to a device that performs communication using a wireless access technology (e.g., 5G NR (New RAT), LTE (Long Term Evolution)), and may be referred to as a communication/wireless/5G device. Although not limited thereto, the wireless device may include a robot 100a, a vehicle 100b-1, 100b-2, an eXtended Reality (XR) device 100c, a hand-held device 100d, and a home appliance 100e), an Internet of Things (IoT) device 100f, and an AI device/server 400. For example, the vehicle may include a vehicle equipped with a wireless communication function, an autonomous driving vehicle, a vehicle capable of performing inter-vehicle communication, and the like. Here, the vehicle may include an Unmanned Aerial Vehicle (UAV) (e.g., a drone). XR devices include AR (Augmented Reality)/VR (Virtual Reality)/MR (Mixed Reality) devices, and it may be implemented in the form of a Head-Mounted Device (HMD), a Head-Up Display (HUD) provided in a vehicle, a television, a smartphone, a computer, a wearable device, a home appliance, a digital signage, a vehicle, a robot, and the like. The portable device may include a smart phone, a smart pad, a wearable device (e.g., a smart watch, smart glasses), a computer (e.g., a laptop computer), and the like. Home appliances may include a TV, a refrigerator, a washing machine, and the like. The IoT device may include a sensor, a smart meter, and the like. For example, the base station and the network may be implemented as a wireless device, and a specific wireless device 200a may operate as a base station/network node to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). In addition, the IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

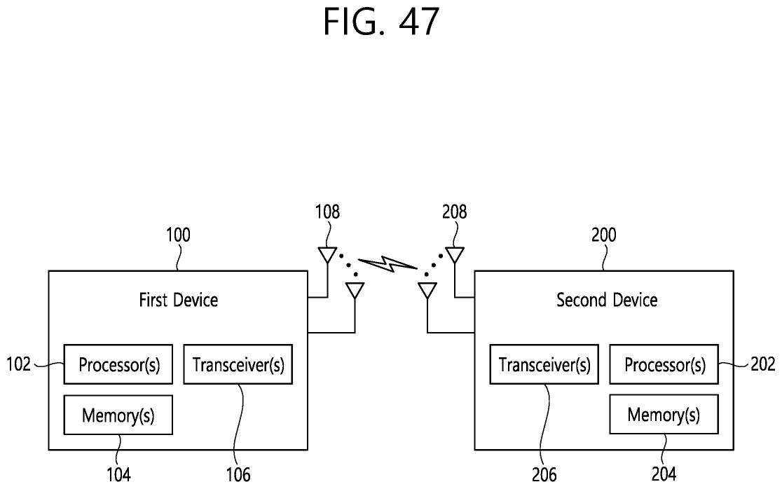

FIG. 47 illustrates a wireless device applicable to the present disclosure.

Referring to FIG. 47, the first wireless device 100 and the second wireless device 200 may transmit and receive wireless signals through various wireless access technologies (e.g., LTE, NR). Here, {first wireless device 100, second wireless device 200} may correspond to {wireless device 100x, base station 200} and/or {wireless device 100x, wireless device 100x} of FIG. 46.

The first wireless device 100 may include one or more processors 102 and one or more memories 104 and additionally further include one or more transceivers 106 and/or one or more antennas 108. The processors 102 may control the memory 104 and/or the transceivers 106 and may be configured to implement the descriptions, functions, procedures, proposals, methods, and/or operational flowcharts disclosed in this document. For example, the processors 102 may process information within the memory 104 to generate first information/signals and then transmit radio signals including the first information/signals through the transceivers 106. In addition, the processor 102 may receive radio signals including second information/signals through the transceiver 106 and then store information obtained by processing the second information/signals in the memory 104. The memory 104 may be connected to the processor 102 and may store a variety of information related to operations of the processor 102. For example, the memory 104 may store software code including commands for performing a part or the entirety of processes controlled by the processor 102 or for performing the descriptions, functions, procedures, proposals, methods, and/or operational flowcharts disclosed in this document. Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. The transceiver 106 may include a transmitter and/or a receiver. The transceiver 106 may be interchangeably used with a radio frequency (RF) unit. In the present disclosure, the wireless device may represent a communication modem/circuit/chip.

The second wireless device 200 may include one or more processors 202 and one or more memories 204 and additionally further include one or more transceivers 206 and/or one or more antennas 208. The processor 202 may control the memory 204 and/or the transceiver 206 and may be configured to implement the descriptions, functions, procedures, proposals, methods, and/or operational flowcharts disclosed in this document. For example, the processor 202 may process information within the memory 204 to generate third information/signals and then transmit radio signals including the third information/signals through the transceiver 206. In addition, the processor 202 may receive radio signals including fourth information/signals through the transceiver 106 and then store information obtained by processing the fourth information/signals in the memory 204. The memory 204 may be connected to the processor 202 and may store a variety of information related to operations of the processor 202. For example, the memory 204 may store software code including commands for performing a part or the entirety of processes controlled by the processor 202 or for performing the descriptions, functions, procedures, proposals, methods, and/or operational flowcharts disclosed in this document. Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. The transceiver 206 may include a transmitter and/or a receiver. The transceiver 206 may be interchangeably used with an RF unit. In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. In addition, the one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. In addition, the one or more processors 102 and 202 may perform control so that the one or more transceivers 106 and 206 may receive user data, control information, or radio signals from one or more other devices. In addition, the one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

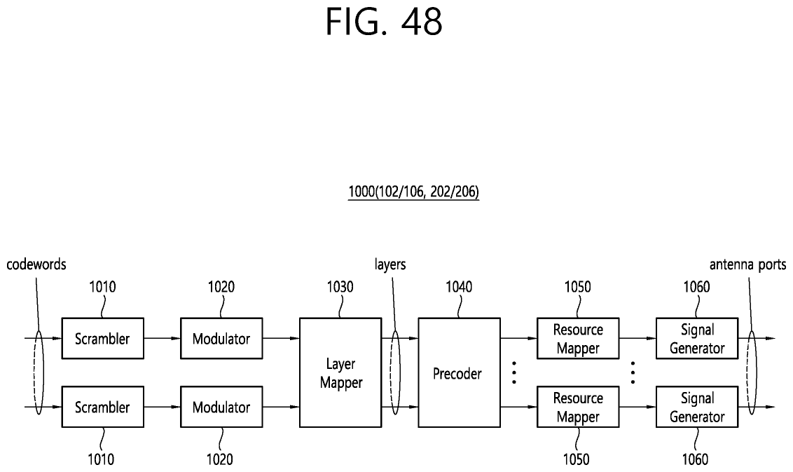

FIG. 48 exemplifies a signal processing circuit for a transmission signal.

Referring to FIG. 48, a signal processing circuit 1000 includes a scrambler 1010, a modulator 1020, a layer mapper 1030, a precoder 1040, a resource mapper 1050, and a signal generator 1060. The operations/functions of FIG. 48 may be performed in the processors 102 and 202 and/or the transceivers 106 and 206 of FIG. 47 but are not limited thereto. The hardware elements of FIG. 48 may be implemented in the processors 102 and 202 and/or the transceivers 106 and 206 of FIG. 47. For example, blocks 1010 to 1060 may be implemented in the processors 102 and 202 of FIG. 47. In addition, blocks 1010 to 1050 may be implemented in the processors 102 and 202 of FIG. 47, and block 1060 may be implemented in the transceivers 106 and 206 of FIG. 47.

A codeword may be converted into a wireless signal through the signal processing circuit 1000 of FIG. 48. Here, the codeword is an encoded bit sequence of an information block. The information block may include a transport block (e.g., a UL-SCH transport block or a DL-SCH transport block). The wireless signal may be transmitted through various physical channels (e.g., PUSCH or PDSCH).

Specifically, the codeword may be converted into a scrambled bit sequence by the scrambler 1010. The scramble sequence used for scrambling is generated based on an initialization value, and the initialization value may include ID information of a wireless device. The scrambled bit sequence may be modulated by the modulator 1020 into a modulation symbol sequence. The modulation scheme may include pi/2-binary phase shift keying (pi/2-BPSK), m-phase shift keying (m-PSK), m-quadrature amplitude modulation (m-QAM), and the like. The complex modulation symbol sequence may be mapped to one or more transport layers by the layer mapper 1030. The modulation symbols of each transport layer may be mapped to the corresponding antenna port(s) by the precoder 1040 (precoding). An output z of the precoder 1040 may be obtained by multiplying an output y of the layer mapper 1030 by an N*M precoding matrix W. Here, N is the number of antenna ports and M is the number of transmission layers. Here, the precoder 1040 may perform precoding after performing transform precoding (e.g., DFT transform) on complex modulation symbols. Also, the precoder 1040 may perform precoding without performing transform precoding.

The resource mapper 1050 may map modulation symbols of each antenna port to a time-frequency resource. The time-frequency resource may include a plurality of symbols (e.g., CP-OFDMA symbols or DFT-s-OFDMA symbols) in a time domain and may include a plurality of subcarriers in a frequency domain. The signal generator 1060 may generate a wireless signal from the mapped modulation symbols, and the generated wireless signal may be transmitted to another device through each antenna. To this end, the signal generator 1060 may include an inverse fast Fourier transform (IFFT) module, a cyclic prefix (CP) inserter, a digital-to-analog converter (DAC), a frequency uplink converter, and the like.

A signal processing process for a received signal in the wireless device may be configured as the reverse of the signal processing process (1010 to 1060) of FIG. 48. For example, a wireless device (e.g., 100 or 200 in FIG. 47) may receive a wireless signal from the outside through an antenna port/transmitter. The received wireless signal may be converted into a baseband signal through a signal restorer. To this end, the signal restorer may include a frequency downlink converter, an analog-to-digital converter (ADC), a CP canceller, and a fast Fourier transform (FFT) module. Thereafter, the baseband signal may be restored into a codeword through a resource de-mapper process, a postcoding process, a demodulation process, and a de-scramble process. The codeword may be restored to an original information block through decoding. Accordingly, a signal processing circuit (not shown) for a received signal may include a signal restorer, a resource demapper, a postcoder, a demodulator, a descrambler, and a decoder.

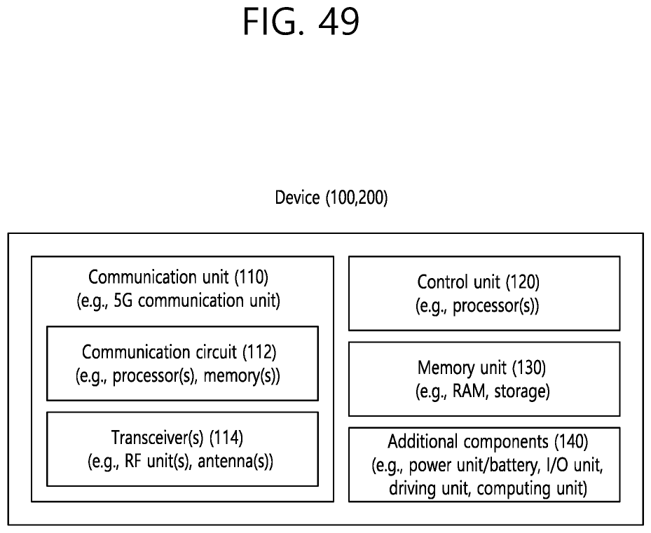

FIG. 49 shows another example of a wireless device applied to the present disclosure. The wireless device can be implemented in various forms according to use-examples/services (Refer to FIG. 46).

Referring to FIG. 49, wireless devices (100, 200) may correspond to the wireless devices (100, 200) of FIG. 47 and may be configured by various elements, components, units/portions, and/or modules. For example, each of the wireless devices (100, 200) may include a communication unit (110), a control unit (120), a memory unit (130), and additional components (140). The communication unit may include a communication circuit (112) and transceiver(s) (114). For example, the communication circuit (112) may include the one or more processors (102, 202) and/or the one or more memories (104, 204) of FIG. 47. For example, the transceiver(s) (114) may include the one or more transceivers (106, 206) and/or the one or more antennas (108, 208) of FIG. 47. The control unit (120) is electrically connected to the communication unit (110), the memory (130), and the additional components (140) and controls overall operation of the wireless devices. For example, the control unit (120) may control an electric/mechanical operation of the wireless device based on programs/code/instructions/information stored in the memory unit (130). The control unit (120) may transmit the information stored in the memory unit (130) to the exterior (e.g., other communication devices) via the communication unit (110) through a wireless/wired interface or store, in the memory unit (130), information received through the wireless/wired interface from the exterior (e.g., other communication devices) via the communication unit (110).

The additional components (140) may be variously configured according to types of wireless devices. For example, the additional components (140) may include at least one of a power unit/battery, input/output (I/O) unit, a driving unit, and a computing unit. The wireless device may be implemented in the form of, without being limited to, the robot (100a of FIG. 46), the vehicles (100b-1, 100b-2 of FIG. 46), the XR device (100c of FIG. 46), the hand-held device (100d of FIG. 46), the home appliance (100e of FIG. 46), the IoT device (100f of FIG. 46), a digital broadcast UE, a hologram device, a public safety device, an MTC device, a medicine device, a fintech device (or a finance device), a security device, a climate/environment device, the AI server/device (400 of FIG. 46), the BSs (200 of FIG. 46), a network node, and so on. The wireless device may be used in a mobile or fixed place according to a usage-example/service.

In FIG. 49, the entirety of the various elements, components, units/portions, and/or modules in the wireless devices (100, 200) may be connected to each other through a wired interface or at least a part thereof may be wirelessly connected through the communication unit (110). For example, in each of the wireless devices (100, 200), the control unit (120) and the communication unit (110) may be connected by wire and the control unit (120) and first units (e.g., 130, 140) may be wirelessly connected through the communication unit (110). Each element, component, unit/portion, and/or module within the wireless devices (100, 200) may further include one or more elements. For example, the control unit (120) may be configured by a set of one or more processors. As an example, the control unit (120) may be configured by a set of a communication control processor, an application processor, an Electronic Control Unit (ECU), a graphical processing unit, and a memory control processor. As another example, the memory (130) may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 49 will be described in detail with reference to the drawings.

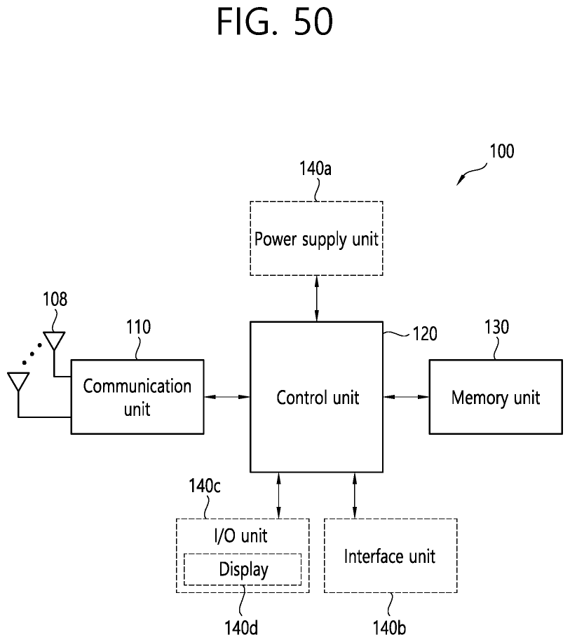

FIG. 50 illustrates a portable device applied to the present disclosure. The portable device may include a smartphone, a smart pad, a wearable device (e.g., smart watch or smart glasses), a portable computer (e.g., a notebook), etc. The portable device may be referred to as a mobile station (MS), a user terminal (UT), a mobile subscriber station (MSS), a subscriber station (SS), an advanced mobile station (AMS), or a wireless terminal (WT).

Referring to FIG. 50, the portable device 100 may include an antenna unit 108, a communication unit 110, a controller 120, a memory unit 130, a power supply unit 140a, an interface unit 140b, and input/output unit 140c. The antenna unit 108 may be configured as a part of the communication unit 110. Blocks 110 to 130/140a to 140c correspond to blocks 110 to 130/140 of FIG. 49, respectively.

The communication unit 110 may transmit and receive signals (e.g., data, control signals, etc.) with other wireless devices and BSs. The controller 120 may perform various operations by controlling components of the portable device 100. The controller 120 may include an application processor (AP). The memory unit 130 may store data/parameters/programs/codes/commands required for driving the portable device 100. Also, the memory unit 130 may store input/output data/information, and the like. The power supply unit 140a supplies power to the portable device 100 and may include a wired/wireless charging circuit, a battery, and the like. The interface unit 140b may support connection between the portable device 100 and other external devices. The interface unit 140b may include various ports (e.g., audio input/output ports or video input/output ports) for connection with external devices. The input/output unit 140c may receive or output image information/signal, audio information/signal, data, and/or information input from a user. The input/output unit 140c may include a camera, a microphone, a user input unit, a display unit 140d, a speaker, and/or a haptic module.

For example, in the case of data communication, the input/output unit 140c acquires information/signals (e.g., touch, text, voice, image, or video) input from the user, and the acquired information/signals may be stored in the memory unit 130. The communication unit 110 may convert information/signals stored in the memory into wireless signals and may directly transmit the converted wireless signals to other wireless devices or to a BS. In addition, after receiving a wireless signal from another wireless device or a BS, the communication unit 110 may restore the received wireless signal to the original information/signal. The restored information/signal may be stored in the memory unit 130 and then output in various forms (e.g., text, voice, image, video, or haptic) through the input/output unit 140c.

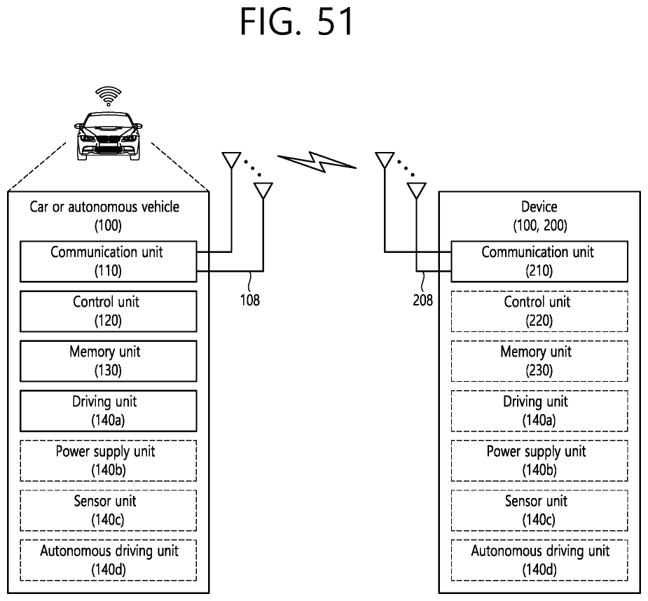

FIG. 51 illustrates a vehicle or an autonomous vehicle applied to the present disclosure. A vehicle or an autonomous vehicle may be implemented as a moving robot, a vehicle, a train, an aerial vehicle (AV), a ship, or the like.

Referring to FIG. 51, a vehicle or autonomous vehicle 100 includes an antenna unit 108, a communication unit 110, a control unit 120, a driving unit 140a, a power supply unit 140b, and a sensor unit 140c, and an autonomous driving unit 140d. The antenna unit 108 may be configured as a portion of the communication unit 110. Blocks 110/130/140a to 140d correspond to blocks 110/130/140 of FIG. 49, respectively.

The communication unit 110 may transmit and receive signals (e.g., data, control signals, etc.) with external devices such as other vehicles, base stations (BSs) (e.g. base station, roadside unit, etc.), and servers. The control unit 120 may perform various operations by controlling elements of the vehicle or the autonomous vehicle 100. The control unit 120 may include an electronic control unit (ECU). The driving unit 140a may cause the vehicle or the autonomous vehicle 100 to travel on the ground. The driving unit 140a may include an engine, a motor, a power train, a wheel, a brake, a steering device, and the like. The power supply unit 140b supplies power to the vehicle or the autonomous vehicle 100, and may include a wired/wireless charging circuit, a battery, and the like. The sensor unit 140c may obtain vehicle status, surrounding environment information, user information, and the like. The sensor unit 140c may include an inertial measurement unit (IMU) sensor, a collision sensor, a wheel sensor, a speed sensor, an inclination sensor, a weight detection sensor, a heading sensor, a position module, a vehicle forward/reverse sensor, a battery sensor, a fuel sensor, a tire sensor, a steering sensor, a temperature sensor, a humidity sensor, an ultrasonic sensor, an illuminance sensor, a pedal position sensor, etc. The autonomous driving unit 140d may implement a technology of maintaining a driving lane, a technology of automatically adjusting a speed such as adaptive cruise control, a technology of automatically traveling along a predetermined route, and a technology of automatically setting a route and traveling when a destination is set.

For example, the communication unit 110 may receive map data, traffic information data, and the like from an external server. The autonomous driving unit 140d may generate an autonomous driving route and a driving plan based on the acquired data. The control unit 120 may control the driving unit 140a so that the vehicle or the autonomous vehicle 100 moves along the autonomous driving route according to the driving plan (e.g., speed/direction adjustment). During autonomous driving, the communication unit 110 may asynchronously/periodically acquire the latest traffic information data from an external server and may acquire surrounding traffic information data from surrounding vehicles. In addition, during autonomous driving, the sensor unit 140c may acquire vehicle state and surrounding environment information. The autonomous driving unit 140d may update the autonomous driving route and the driving plan based on newly acquired data/information. The communication unit 110 may transmit information on a vehicle location, an autonomous driving route, a driving plan, and the like to the external server. The external server may predict traffic information data in advance using AI technology or the like based on information collected from the vehicle or autonomous vehicles and may provide the predicted traffic information data to the vehicle or autonomous vehicles.

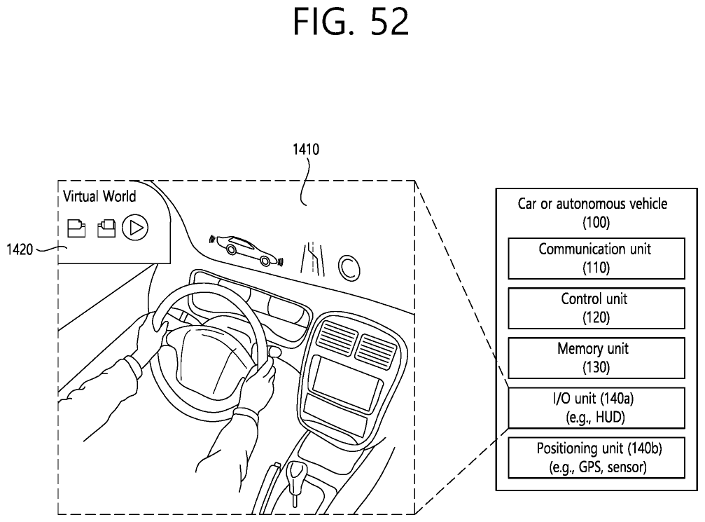

FIG. 52 illustrates a vehicle applied to the present disclosure. Vehicles may also be implemented as means of transportation, trains, aircraft, and ships.

Referring to FIG. 52, the vehicle 100 may include a communication unit 110, a control unit 120, a memory unit 130, an input/output unit 140a, and a position measurement unit 140b. Here, blocks 110 to 130/140a to 140d correspond to blocks 110 to 130/140 of FIG. 49, respectively.

The communication unit 110 may transmit and receive signals (e.g., data, control signals, etc.) with other vehicles or external devices such as a BS. The control unit 120 may perform various operations by controlling components of the vehicle 100. The memory unit 130 may store data/parameters/programs/codes/commands supporting various functions of the vehicle 100. The input/output unit 140a may output an AR/VR object based on information in the memory unit 130. The input/output unit 140a may include a HUD. The location measurement unit 140b may acquire location information of the vehicle 100. The location information may include absolute location information of the vehicle 100, location information within a driving line, acceleration information, location information with surrounding vehicles, and the like. The location measurement unit 140b may include a GPS and various sensors.

For example, the communication unit 110 of the vehicle 100 may receive map information, traffic information, etc., from an external server and store the information in the memory unit 130. The location measurement unit 140b may acquire vehicle location information through GPS and various sensors and store the vehicle location information in the memory unit 130. The control unit 120 may generate a virtual object based the on map information, the traffic information, the vehicle location information, and the like, and the input/output unit 140a may display the generated virtual object on a window of the vehicle (1410, 1420). In addition, the control unit 120 may determine whether the vehicle 100 is operating normally within a driving line based on vehicle location information. When the vehicle 100 deviates from the driving line abnormally, the control unit 120 may display a warning on a windshield of the vehicle through the input/output unit 140a. In addition, the control unit 120 may broadcast a warning message regarding a driving abnormality to nearby vehicles through the communication unit 110. Depending on a situation, the control unit 120 may transmit location information of the vehicle and information on driving/vehicle abnormalities to related organizations through the communication unit 110.

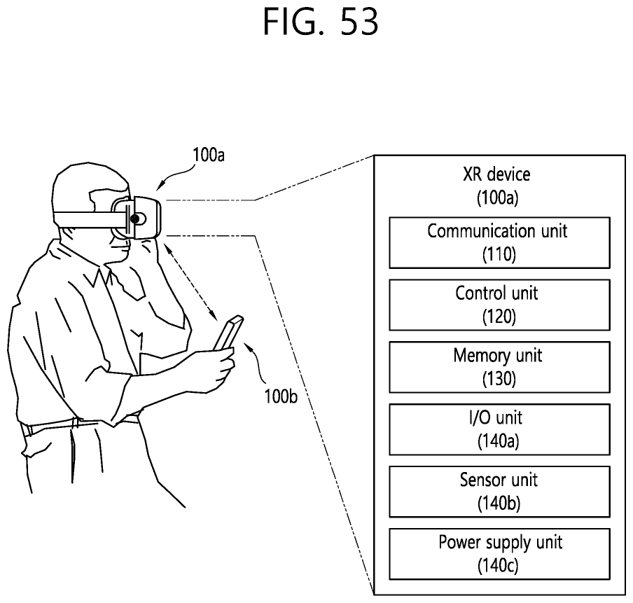

FIG. 53 illustrates an XR device applied to the present disclosure. The XR device may be implemented as an HMD, a head-up display (HUD) provided in a vehicle, a television, a smartphone, a computer, a wearable device, a home appliance, a digital signage, a vehicle, a robot, and the like.

Referring to FIG. 53, the XR device 100a may include a communication unit 110, a control unit 120, a memory unit 130, an input/output unit 140a, a sensor unit 140b, and a power supply unit 140c. Here, blocks 110 to 130/140a to 140c correspond to blocks 110 to 130/140 of FIG. 49, respectively.

The communication unit 110 may transmit and receive signals (e.g., media data, control signals, etc.) with external devices such as other wireless devices, portable devices, media servers. Media data may include images, sounds, and the like. The control unit 120 may perform various operations by controlling components of the XR device 100a. For example, the control unit 120 may be configured to control and/or perform procedures such as video/image acquisition, (video/image) encoding, and metadata generating and processing. The memory unit 130 may store data/parameters/programs/codes/commands required for driving the XR device 100a/generating an XR object. The input/output unit 140a may obtain control information, data, etc. from the outside and may output the generated XR object. The input/output unit 140a may include a camera, a microphone, a user input unit, a display unit, a speaker, and/or a haptic module. The sensor unit 140b may obtain XR device status, surrounding environment information, user information, and the like. The sensor unit 140b may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar. The power supply unit 140c may supply power to the XR device 100a and may include a wired/wireless charging circuit, a battery, and the like.

As an example, the memory unit 130 of the XR device 100a may include information (e.g., data, etc.) necessary for generating an XR object (e.g., AR/VR/MR object). The input/output unit 140a may acquire a command to manipulate the XR device 100a from a user, and the control unit 120 may drive the XR device 100a according to the user's driving command. For example, when the user tries to watch a movie, news, etc., through the XR device 100a, the control unit 120 may transmit content request information through the communication unit 130 to another device (for example, the portable device 100b) or to a media server. The communication unit 130 may download/stream content such as movies and news from another device (e.g., the portable device 100b) or the media server to the memory unit 130. The control unit 120 may control and/or perform procedures such as video/image acquisition, (video/image) encoding, and metadata generating/processing for the content, and generate/output an XR object based on information on a surrounding space or a real object through the input/output unit 140a/sensor unit 140b.

In addition, the XR device 100a may be wirelessly connected to the portable device 100b through the communication unit 110, and an operation of the XR device 100a may be controlled by the portable device 100b. For example, the portable device 100b may operate as a controller for the XR device 100a. To this end, the XR device 100a may acquire 3D location information of the portable device 100b, generate an XR entity corresponding to the portable device 100b, and output the generated XR entity.

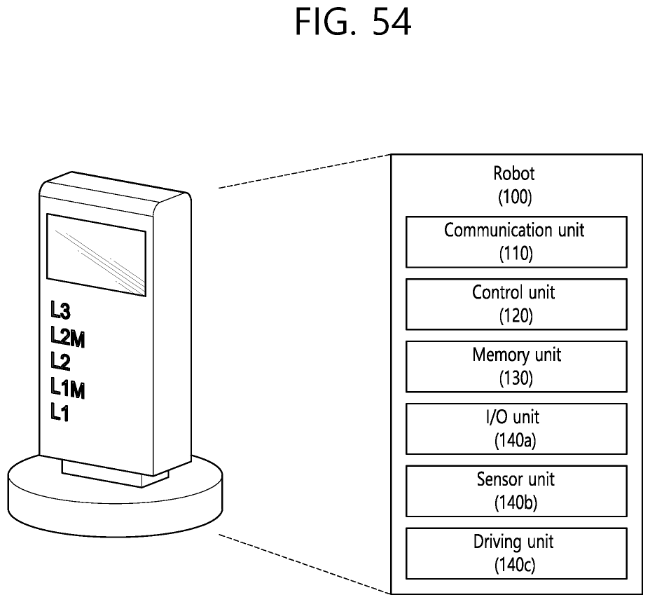

FIG. 54 illustrates a robot applied to the present disclosure. Robots may be classified as industrial, medical, household, military, etc. depending on the purpose or field of use.

Referring to FIG. 54, a robot 100 may include a communication unit 110, a control unit 120, a memory unit 130, an input/output unit 140a, a sensor unit 140b, and a driving unit 140c. Here, blocks 110 to 130/140a to 140d correspond to blocks 110 to 130/140 of FIG. 49, respectively.

The communication unit 110 may transmit and receive signals (e.g., driving information, control signals, etc.) with other wireless devices, other robots, or external devices such as a control server. The control unit 120 may perform various operations by controlling components of the robot 100. The memory unit 130 may store data/parameters/programs/codes/commands supporting various functions of the robot 100. The input/output unit 140a may acquire information from the outside of the robot 100 and may output the information to the outside of the robot 100. The input/output unit 140a may include a camera, a microphone, a user input unit, a display unit, a speaker, and/or a haptic module. The sensor unit 140b may obtain internal information, surrounding environment information, user information, and the like of the robot 100. The sensor unit 140b may include a proximity sensor, an illuminance sensor, an acceleration sensor, a magnetic sensor, a gyro sensor, an inertial sensor, an IR sensor, a fingerprint recognition sensor, an ultrasonic sensor, an optical sensor, a microphone, a radar, and the like. The driving unit 140c may perform various physical operations such as moving a robot joint. In addition, the driving unit 140c may cause the robot 100 to travel on the ground or fly in the air. The driving unit 140c may include an actuator, a motor, a wheel, a brake, a propeller, and the like.

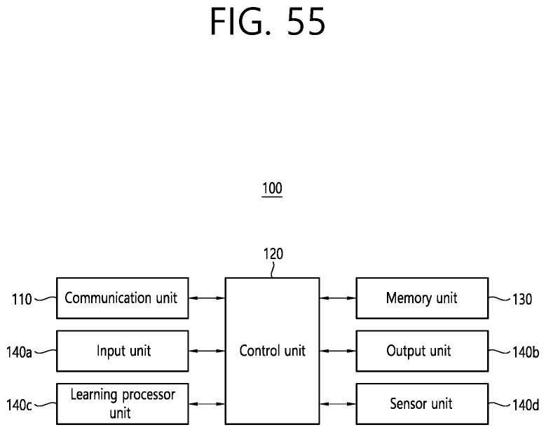

FIG. 55 illustrates an AI device applied to the present disclosure. AI devices may be implemented as fixed devices or moving devices such as TVs, projectors, smartphones, PCs, notebooks, digital broadcasting UEs, tablet PCs, wearable devices, set-top boxes (STBs), radios, washing machines, refrigerators, digital signage, robots, vehicles, etc.

Referring to FIG. 55, the AI device 100 may include a communication unit 110, a control unit 120, a memory unit 130, an input/output unit 140a/140b, a learning processor unit 140c, and a sensor unit. Blocks 110 to 130/140a to 140d correspond to blocks 110 to 130/140 of FIG. 49, respectively.

The communication unit 110 may transmit and receive wireless signals (e.g., sensor information, user input, learning model, control signals, etc.) with external devices such as another AI device (e.g., FIG. 46, 100x, 200, or 400) or an AI server (e.g., 400 in FIG. 46) using wired/wireless communication technology. To this end, the communication unit 110 may transmit information in the memory unit 130 to an external device or may transfer a signal received from the external device to the memory unit 130.

The control unit 120 may determine at least one executable operation of the AI device 100 based on information determined or generated using a data analysis algorithm or a machine learning algorithm. In addition, the control unit 120 may perform a determined operation by controlling the components of the AI device 100. For example, the control unit 120 may request, search, receive, or utilize data from the learning processor unit 140c or the memory unit 130, and may control components of the AI device 100 to execute a predicted operation among at least one an executable operation or an operation determined to be desirable. In addition, the control unit 120 may collect history information including operation content of the AI device 100 or the user's feedback on the operation, and store the collected information in the memory unit 130 or the learning processor unit 140c or transmit the information to an external device such as an AI server (400 of FIG. 46). The collected historical information may be used to update a learning model.

The memory unit 130 may store data supporting various functions of the AI device 100. For example, the memory unit 130 may store data obtained from the input unit 140a, data obtained from the communication unit 110, output data from the learning processor unit 140c, and data obtained from the sensing unit 140. In addition, the memory unit 130 may store control information and/or software codes necessary for the operation/execution of the control unit 120.

The input unit 140a may acquire various types of data from the outside of the AI device 100. For example, the input unit 140a may acquire training data for model training and input data to which the training model is applied. The input unit 140a may include a camera, a microphone, and/or a user input unit. The output unit 140b may generate output related to visual, auditory, or tactile sense. The output unit 140b may include a display unit, a speaker, and/or a haptic module. The sensing unit 140 may obtain at least one of internal information of the AI device 100, surrounding environment information of the AI device 100, and user information by using various sensors. The sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 140c may train a model configured as an artificial neural network using training data. The learning processor unit 140c may perform AI processing together with the learning processor unit (400 in FIG. 46) of the AI server. The learning processor unit 140c may process information received from an external device through the communication unit 110 and/or information stored in the memory unit 130. In addition, an output value of the learning processor unit 140c may be transmitted to an external device through the communication unit 110 and/or may be stored in the memory unit 130.

1. A communication method performed by a user equipment (UE) including a first neural network encoder and a first neural network decoder composed of a neural network, the method comprising:
receiving information from a base station, wherein the information includes a first parameter related to the first neural network encoder and a second parameter related to the first neural network decoder; and
communicating with the base station based on the information,
wherein the UE transmits uplink data to the base station based on the first parameter,
wherein the UE receives downlink data from the base station based on the second parameter, and
wherein the first neural network encoder includes at least one of an interleaver, a recursive systematic convolutional (RSC) code, and an accumulator.

2. The method of claim 1, wherein the information is transmitted based on radio resource control (RRC) signaling, medium access control (MAC) signaling or layer 1 (L1) signaling.

3. The method of claim 1, wherein the information informs of at least one of a type of the neural network, a number of layers of the neural network, an activation function for each of the layers, an optimization method for the neural network, or a weight for each of the layer.

4. The method of claim 3, wherein the weight is defined in advance.

5. The method of claim 1, wherein the base station includes a second neural network encoder and a second neural network decoder composed of the neural network.

6. The method of claim 5, wherein each of a first set comprising the first network encoder and the second network decoder and a second set comprising the first network decoder and the second network encoder constitute a neural encoder.

7. The method of claim 1, wherein the neural network encoder comprises a plurality of neural networks arranged in parallel, and
wherein some of the plurality of the neural networks have different input data.

8. The method of claim 7, wherein the different input data are generated based on a plurality of interleavers.

9. The method of claim 7, wherein the different input data are generated based on an interleaver and an accumulator.

10. The method of claim 7, wherein the different input data are generated based on an interleaver and a recursive systematic convolutional (RSC) code.

11. The method of claim 7, wherein the different input data comprises systematic input data.

12. The method of claim 1, wherein the first parameter and the second parameter are generated based on training performed by the base station.

13. The method of claim 1, wherein the first parameter and the second parameter are generated by a training device, and
wherein the UE receives the first parameter and the second parameter transmitted to the base station by the training device from the base station.

14. The method of claim 1, wherein the information comprises at least one of a transmission-related weight and a reception-related weight.

15. A user equipment (UE) including a neural network encoder and a neural network decoder composed of a neural network, the UE comprising:
at least one memory storing instructions;
at least one transceiver; and
at least one processor coupling the at least one memory and the at least one transceiver, wherein the at least one processor execute the instructions,
wherein the at least one processor:
receives information from a base station, wherein the information includes a first parameter related to the first neural network encoder and a second parameter related to the first neural network decoder; and
communicates with the base station based on the information,
wherein the UE transmits uplink data to the base station based on the first parameter,
wherein the UE receives downlink data from the base station based on the second parameter, and
wherein the first neural network encoder includes at least one of an interleaver, a recursive systematic convolutional (RSC) code, and an accumulator.

16. (canceled)

17. A base station composed of a neural network, the base station comprising:
at least one memory storing instructions;
at least one transceiver; and
at least one processor coupling the at least one memory and the at least one transceiver, wherein the at least one processor execute the instructions,
wherein the at least one processor:
performs training on the neural network;
obtains a parameter based on the training; and
transmits information including the parameter to a user equipment (UE),
wherein the UE includes an encoder and a decoder for the neural network, and
wherein the parameter is related with the encoder and the decoder.

18-19. (canceled)
